(19) United States
(12) Patent Application Publication
(10) Pub. No.: US 2015/0341985 A1
(43) Pub. Date: Nov. 26, 2015

(54) HEATER AND IMAGE HEATING APPARATUS INCLUDING THE SAME

(71) Applicant: CANON KABUSHIKI KAISHA, Tokyo (JP)

(72) Inventor: Toshinori Nakayama, Kashiwa-shi (JP)

(21) Appl. No.: 14/718,557

(22) Filed: May 21, 2015

(30) Foreign Application Priority Data
May 26, 2014 (JP) 2014-108591

(51) Int. Cl. H05B 3/00; H05B 3/06; G03G 15/20; H05B 3/03

(52) U.S. Cl. CPC H05B 3/0014; H05B 3/03; H05B 3/06; G03G 15/2053

(57) ABSTRACT

A heater usable with an image heating apparatus including first and second terminals includes electrodes including first and second electrodes connectable the first and second terminals, respectively, the first electrodes and the second electrodes extend longitudinally; heat generating portions between adjacent electrodes; a first electric line connected with the first electrodes, the first line being extending with a gap between the heat generating portions, a second electric line connected with the second electrode connected with the heat generating portions in a first heat generating region, a third electric line connected with the second electrode connected with the heat generating portions in a second heat generating region, the second electric line being extended adjacent to the second electric line, wherein a gap between the second and third electric lines in the widthwise direction is smaller than the gap between the first and second electrodes in the widthwise direction.

### FIELD OF THE INVENTION AND RELATED ART

The present invention relates to a heater for heating an image on a sheet and an image heating apparatus provided with the same. The image heating apparatus is usable with an image forming apparatus such as a copying machine, a printer, a facsimile machine, a multifunction machine having a plurality of functions thereof or the like.

An image forming apparatus is known in which a toner image is formed on the sheet and is fixed on the sheet by heat and pressure in a fixing device (image heating apparatus). As for such a fixing device, a type of fixing device is recently proposed (Japanese Laid-open Patent Application 2012-37613) in which a heat generating element (heater) is contacted to an inner surface of a thin flexible belt to apply heat to the belt. Such a fixing device is advantageous in that the structure has a low thermal capacity, and therefore, the temperature rise to the fixing operation allowable is quick.

Such a fixing device is advantageous in that the structure has a low thermal capacity, and therefore, the temperature rise to the fixing operation allowable is quick. FIG. 16 is a circuit diagram of the heater disclosed in Japanese Laid-open Patent Application 2012-37613. As shown in FIG. 16, the fixing device comprises electrodes 1027 (1027a-1027f) arranged in a longitudinal direction of a substrate 1021 and heat generating resistance layers 1025), and the electric power supply is supplied through the electrodes to the heat generating resistance layers 1025 (1025a-1025e) so that the heat generating resistance layer generates heat.

In this fixing device, each electrode is electrically connected with an electroconductive line layers 1029 (1029a, 1029b) formed on the substrate. The electroconductive line layer extends toward a longitudinal end portion of the substrate, and is connectable with a voltage supply circuit by an electroconductive member. More particularly, an electroconductive line layer 1029d connected with a plurality of electrodes, an electroconductive line layer 1029h connected with an electrode 1027b and an electroconductive line layer 1029g connected with an electrode 1027d extended toward the one longitudinal end of the substrate. The plurality of electrodes connected with the electroconductive line layer 1029d are electrodes 1027a, 1027c, 1027e, 1027g, 1027i, 1027k, 1027m, 1027o. An electroconductive line layer 1029c connected with a plurality of electrodes, an electroconductive line layer 1029i connected with an electrode 1027q, and an electroconductive line layer 1029j connected with an electrode 1027s extend toward the other longitudinal end of the substrate. The plurality of electrodes connected with the electroconductive line layer 1029c are electrodes 1027f, 1027h, 1027j, 10271, 1027n, 1027p, 1027r, 1027t.

In the one end portion of the substrate with respect to the longitudinal direction, the electrode 1027a and the electroconductive line layers 1029g and g, 1029h are connectable with the electroconductive members, respectively. In the other end portion of the substrate with respect to the longitudinal direction, the electrode 1027f and the electroconductive line layers 1029i and 1029j are connectable with respective electroconductive members. More in detail, the opposite longitudinal end portions of the substrate is not coated with an insulation layer for protecting the electroconductive lines, and therefore, the electrodes 1027a, 1027t and electroconductive line layers 1029g, 1029h, 1029i, 1029j are exposed. By the electroconductive member contacting the exposed portions of the electrodes 1027a, 1027t and the electroconductive line layers 1029g, 1029h, 1029i, 1029j, a heat generating element 1006 is connected to the voltage supply circuit.

The voltage supply circuit includes an AC voltage source and switches 1033 (1033e, 1033f, 1033g, 1033h), by combinations of the actuations of which heater energization pattern is controlled. That is, each electroconductive line layer 1029 is connected with either one of a voltage source contact 1031a or a voltage source contact 1031b, depending on the connection pattern in the voltage supply circuit. With such a structure, the fixing device of Japanese Laid-open Patent Application 2012-37613 changes the width of the heat generating region of the heat generating resistance layer 1025 in accordance with the width size of the sheet.

The fixing device of Japanese Laid-open Patent Application 2012-37613 involves a point to improve about the electroconductive lines. The voltage source contact (1031a or 1031b) to which the electroconductive line layers on the substrate changes depending on the connection pattern in the voltage supply circuit, and therefore, a large potential difference can be produced between adjacent electroconductive lines.

As shown in FIG. 16, when the heat generating element 1006 generates heat for a maximum size (width) sheet, the electroconductive line layer 1029i and the electroconductive line layer 1029j are connected with the voltage source contact 1031a. Therefore, the potentials of the electroconductive line layer 1029i and the electroconductive line layer 1029j are substantially the same. On the other hand, when the heat generating element 1006 generate the heat for an intermediate size (width) sheet, the electroconductive line layer 1029i is connected with the voltage source contact 1031a, and in the electroconductive line layer 1029j is connected with the voltage source contact 1031b. Therefore, a large potential difference is produced between the electroconductive line layer 1029i and the electroconductive line layer 1029j.

The adjacent electroconductive lines are required to be insulated so as not to cause short circuit therebetween, and for this purpose a gap is required therebetween. The short circuit tends to occur more when the potential difference between the electroconductive lines is large, and therefore, an assured insulation is required when the potential difference between the electroconductive lines is large. Therefore, the gap between the electroconductive lines with the possibility of large potential difference therebetween tends to be large.

Thus, the gap between the electroconductive line layer 1029i and the electroconductive line layer 1029j is large. This results in wide space for providing the electroconductive lines on the substrate 1021 which will be to a large width of the substrate. For this reason, the increase in cost of the heater 600 arises with the upsizing of the substrate 1021. A heater with image a width size of the heat generating region is changeable is desired to have cone. The increase of a width resulting from the electroconductive lines on the substrate can be suppressed.

### SUMMARY OF THE INVENTION

It is an object of the present invention to provide a heater with which the increase of the width of the substrate is suppressed.

According to an aspect of the present invention, there is provided a heater usable with an image heating apparatus including an electric energy supplying portion provided with a first terminal and a second terminal, and an endless belt for heating an image on a sheet, wherein said heater is contactable to the belt to heat the belt, said heater comprising a substrate; a plurality of electrode portions including a plurality of first electrode portions electrically connectable with the first terminal and a plurality of second electrode portions electrically connectable the second terminal, said first electrode portions and said second electrode portions are arranged in a longitudinal direction of said substrate with spaces between adjacent electrode portions; a plurality of heat generating portions, provided between adjacent electrode portions, respectively, for generating heat by electric power supply between adjacent electrode portions; a first electroconductive line portion electrically connected with said plurality of first electrode portions, said first electroconductive line portion being extending in the longitudinal direction with a gap between itself and said plurality of heat generating portions, in one end portion side with respect to a widthwise direction of said substrate beyond said plurality of heat generating portions; a second electroconductive line portion electrically connected with said second electrode portion electrically connected with said heat generating portions in a first heat generating region arranged in the longitudinal direction, said second electroconductive line portion being extended in the longitudinal direction in the other end portion side with respect to the widthwise direction beyond said plurality of heat generating portions; and a third electroconductive line portion electrically connected with said second electrode portion electrically connected with said heat generating portions in a second heat generating region arranged in the longitudinal direction, said second electroconductive line portion being extended adjacent to said second electroconductive line portion in the longitudinal direction in the other end portion side with respect to the widthwise direction beyond said plurality of heat generating portions; wherein a gap between said second electroconductive line portion and said third electroconductive line portion in the widthwise direction is smaller than the gap between said first electroconductive line portion and said second electrode portion in the widthwise direction.

According to another aspect of the present invention, there is provided an image heating apparatus comprising an electric energy supplying portion provided with a first terminal and a second terminal; a belt configured to heat an image on a sheet; a substrate provided inside said belt and extending in a widthwise direction of said belt; a plurality of electrode portions including a plurality of first electrode portions electrically connectable the first terminal and a plurality of second electrode portions electrically connectable the second terminal, said first electrode portions and said second electrode portions are arranged in a longitudinal direction of said substrate with spaces between adjacent electrode portions; a plurality of heat generating portions, provided between adjacent electrode portions, respectively, for generating heat by electric power supply between adjacent electrode portions, a first electroconductive line portion electrically connected with said plurality of first electrode portions, said first electroconductive line portion being extending in the longitudinal direction with a gap between itself and said plurality of heat generating portions, in one end portion side with respect to a widthwise direction of said substrate beyond said plurality of heat generating portions; a second electroconductive line portion electrically connected with said second electrode portion electrically connected with said heat generating portions in a first heat generating region arranged in the longitudinal direction, said second electroconductive line portion being extended in the longitudinal direction in the other end portion side with respect to the widthwise direction beyond said plurality of heat generating portions; and a third electroconductive line portion electrically connected with said second electrode portion electrically connected with said heat generating portions in a second heat generating region arranged in the longitudinal direction, said second electroconductive line portion being extended adjacent to said second electroconductive line portion in the longitudinal direction in the other end portion side with respect to the widthwise direction beyond said plurality of heat generating portions; wherein when a sheet having a maximum width usable with said apparatus is heated, electric energy is supplied through said first electroconductive line and all of electroconductive line portions including said second electroconductive line portion and said third electroconductive line portion so that all of said heat generating portions generate heat, and wherein when a sheet having a width smaller than the maximum width is heated, electric energy is supplied through said first electroconductive line portion and a part of said electroconductive line portions so that a part of said heat generating portions generate heat, and wherein a gap between said second electroconductive line portion and said third electroconductive line portion in the widthwise direction is smaller than the gap between said first electroconductive line portion and said second electrode portion in the widthwise direction

Further features of the present invention will become apparent from the following description of exemplary embodiments with reference to the attached drawings.

### BRIEF DESCRIPTION OF THE DRAWINGS

FIG. 1 is a section of view of the image forming apparatus according to an Embodiment 1 of the present invention.

FIG. 2 is a sectional view of an image heating apparatus according to an Embodiment 1 of the present invention.

FIG. 3 is a front view of an image heating apparatus according to Embodiments 1 of the present invention.

FIG. 4 illustrates a structure of a heater Embodiment 1.

FIG. 5 illustrates the structural the relationship of the image heating apparatus according to an Embodiment 1.

FIG. 6 illustrates a connector.

FIG. 7 illustrates a housing.

FIG. 8 illustrates a contact terminal

FIG. 9 is an illustration of the electroconductive lines on the substrate in Embodiment 1.

FIG. 10 illustrates the structural the relationship of the image heating apparatus according to an Embodiment 2.

FIG. 11 is an illustration of the electroconductive lines on the substrate in Embodiment 2.

FIG. 12 illustrates the structural the relationship of the image heating apparatus according to an Embodiment 3.

FIG. 13 is an illustration of the electroconductive lines on the substrate in Embodiment 1.

FIG. 14 is an illustration of the electroconductive lines on the substrate in Embodiment 4.

FIG. 15 is a circuit diagram of a conventional heater.

FIG. 16 is a circuit diagram of a conventional heater.

FIG. 17 is an illustration (a) of heat generating type used with a heater, and an illustration (b) of a switching type for a heat generating region used with the heater.

FIG. 18 illustrates mounting of a connector.

### DESCRIPTION OF THE EMBODIMENTS

Embodiments of the present invention will be described in conjunction with the accompanying drawings. In this embodiment, the image forming apparatus is a laser beam printer using an electrophotographic process as an example. The laser beam printer will be simply called printer.

### Embodiment 1

### Image Forming Apparatus

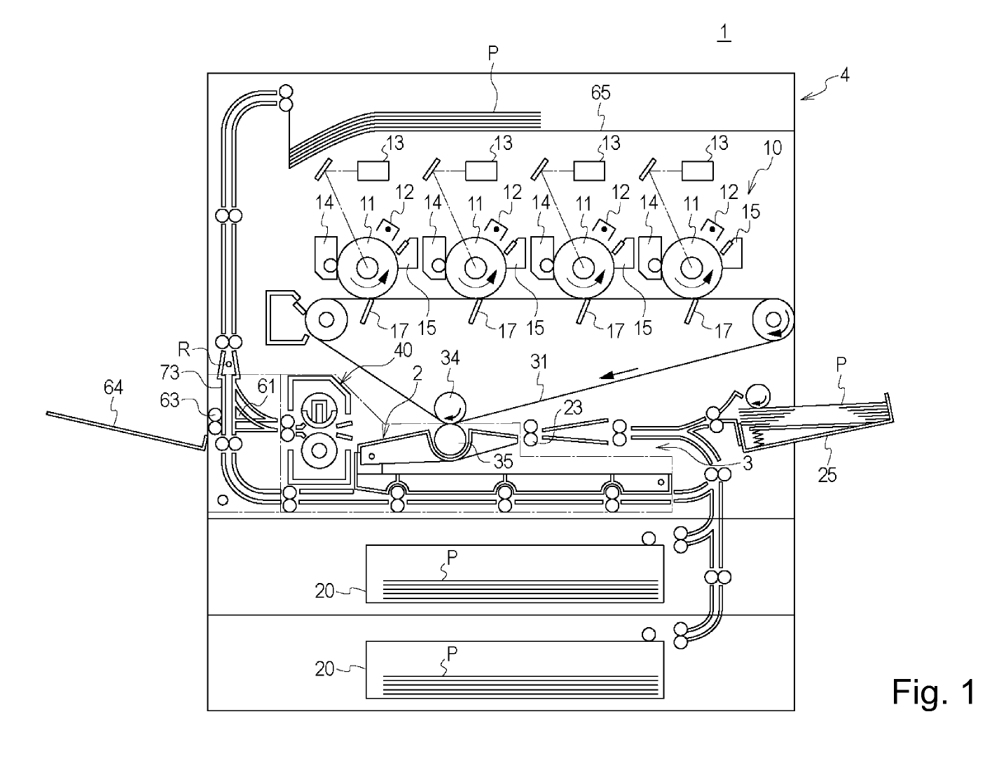

FIG. 1 is a sectional view of the printer 1 which is the image forming apparatus of this embodiment. The printer 1 comprises an image forming station 10 and a fixing device 40, in which a toner image formed on the photosensitive drum 11 is transferred onto a sheet P, and is fixed on the sheet P, by which an image is formed on the sheet P. Referring to FIG. 1, the structures of the apparatus will be described in detail.

As shown in FIG. 1, the printer 1 includes image forming stations 10 for forming respective color toner images Y (yellow), M (magenta), C (cyan) and Bk (black). The image forming stations 10 includes respective photosensitive drums 11 (11Y, 11M, 11C, 11Bk) corresponding to Y, M, C, Bk colors are arranged in the order named from the left side. Around each drum 11, similar elements are provided as follows: A charger 12 (12Y, 12M, 12C, 12Bk); Exposure device 13 (13Y, 13M, 13C, 13Bk); Developing device 14 (14Y, 14M, 14C, 14Bk); A primary transfer blade 17 (17Y, 17M, 17C, 17Bk); and Cleaner 15 (15Y, 15M, 15C, 15Bk). The structure for the Bk toner image formation will be described as a representative, and the descriptions for the other colors are omitted for simplicity by assigning the like reference numerals. So, the elements will be simply called photosensitive drum 11, charger 12, exposure device 13, developing device 14, primary transfer blade 17 and cleaner 15 with these reference numerals.

The photosensitive drum 11 as an electrophotographic photosensitive member is rotated by a driving source (unshown) in the direction indicated by an arrow (counterclockwise direction in FIG. 1). Around the photosensitive drum 11, the charger 12, the exposure device 13, the developing device 14, the primary transfer blade 17 and the cleaner 15 are provided in the order named.

A surface of the photosensitive drum 11 is electrically charged by the charger 12. Thereafter, the surface of the photosensitive drum 11 exposed to a laser beam in accordance with image information by the exposure device 13, so that an electrostatic latent image is formed. The electrostatic latent image is developed into a Bk toner image by the developing device 14. At this time, similar processes are carried out for the other colors. The toner image is transferred from the photosensitive drum 11 onto an intermediary transfer belt 31 by the primary transfer blade 17 sequentially (primary-transfer). The toner remaining on the photosensitive drum 11 after the primary-image transfer is removed by the cleaner 15. By this, the surface of the photosensitive drum 11 is cleaned so as to be prepared for the next image formation.

On the other hand, the sheet P contained in a feeding cassette 20 are placed on a multi-feeding tray 25 is picked up by a feeding mechanism (unshown) and fed to a pair of registration rollers. The sheet P is a member on which the image is formed. Specific examples of the sheet P is plain paper, thick sheet, resin material sheet, overhead projector film or the like. The pair of registration rollers 23 once stops the sheet P the correct oblique feeding. The registration rollers 23 then feed the sheet P into between the intermediary transfer belt 31 and the secondary transfer roller 35 in timed relation with the toner image on the intermediary transfer belt 31. The roller 35 functions to transfer the color toner images from the belt 31 onto the sheet P. Thereafter, the sheet P is fed into the fixing device (image heating apparatus) 40. The fixing device 40 applies heat and pressure to the toner image T on the sheet P to fix the toner image on the sheet P.

### [Fixing Device]

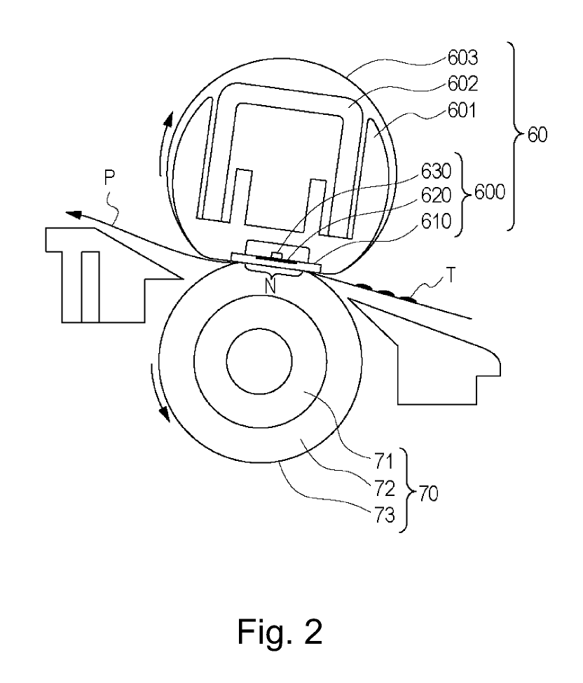

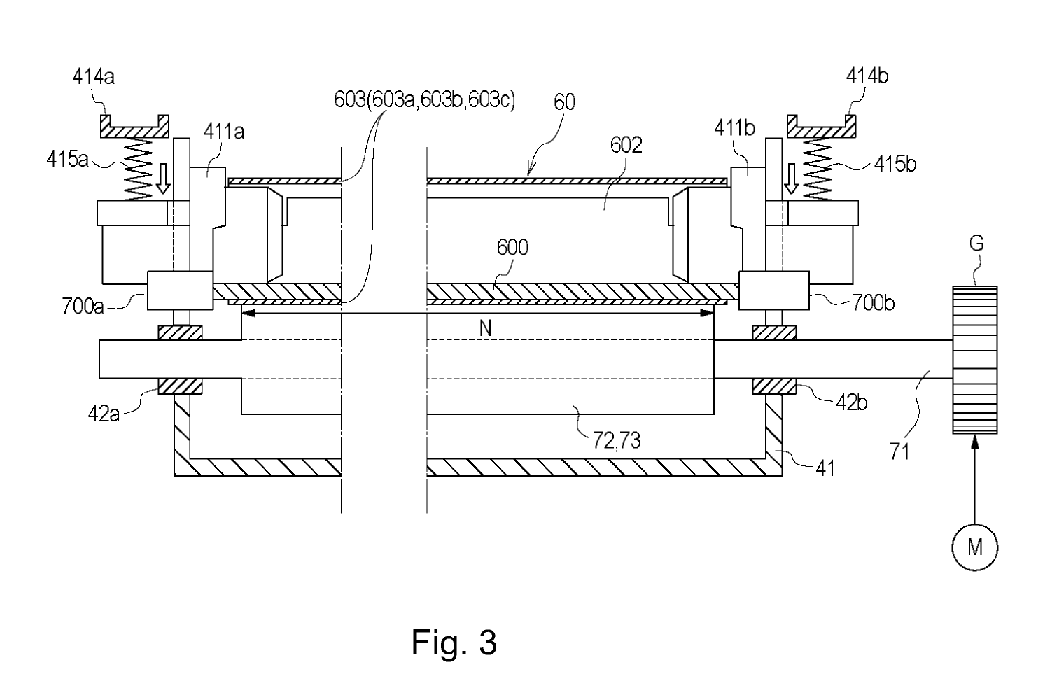

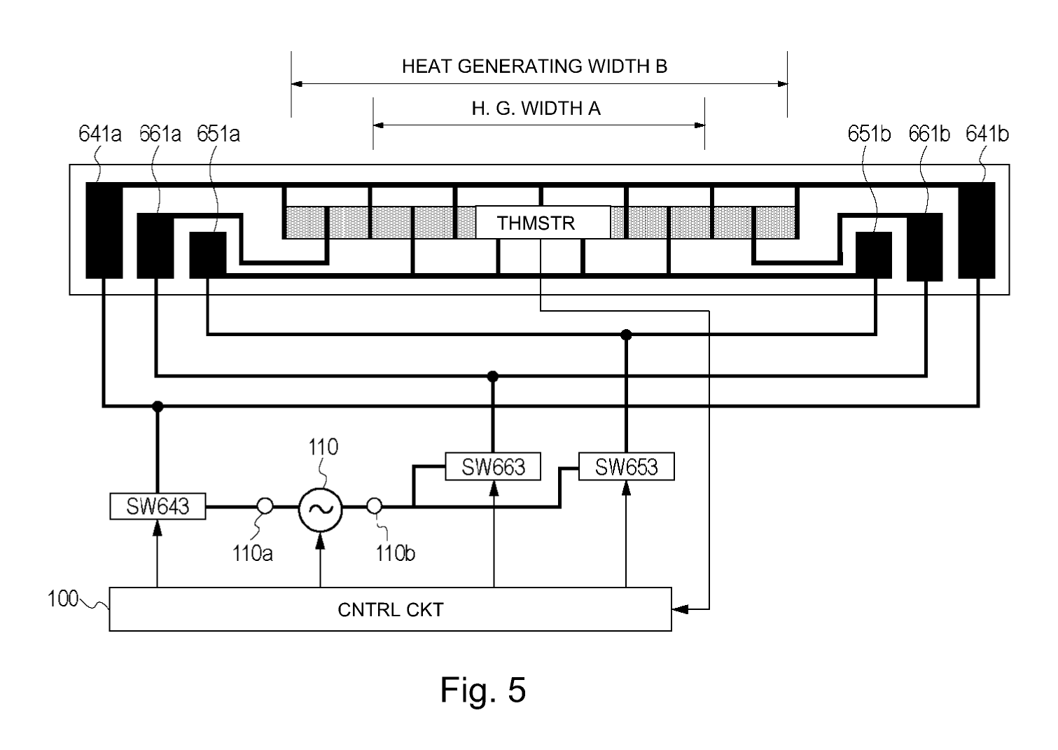

The fixing device 40 which is the image heating apparatus used in the printer 1 will be described FIG. 2 is a sectional view of the fixing device 40 FIG. 3 is a front view of the fixing device 40 FIG. 5 illustrates a structural relationship of the fixing device 40.

The fixing device 40 is an image heating apparatus for heating the image on the sheet by a heater unit 60 (unit 60). The unit 60 includes a flexible thin fixing belt 603 and a heater 600 contacted to the inner surface of the belt 603 to heat the belt 603 (low thermal capacity structure). Therefore, the belt 603 can be efficiently heated, so that quick temperature rise at the start of the fixing operation is accomplished. As shown in FIG. 2, the belt 603 is nipped between the heater 600 and the pressing roller 70 (roller 70), by which a nip N is formed. The belt 603 rotates in the direction indicated by the arrow (clockwise in FIG. 2), and the roller 70 is rotated in the direction indicated by the arrow (counterclockwise in FIG. 2) 29 to nip and feed the sheet P supplied to the nip N. At this time, the heat from the heater 600 is supplied to the sheet P through the belt 603, and therefore, the toner image T on the sheet P is heated and pressed by the nip N, so that the toner image it fixed on the sheet P by the heat and pressure. The sheet P having passed through the fixing nip N is separated from the belt 603 and is discharged. In this embodiment, the fixing process is carried out as described above. The structure of the fixing device 40 will be described in detail.

Unit 60 is a unit for heating and pressing an image on the sheet P. A longitudinal direction of the unit 60 is parallel with the longitudinal direction of the roller 70. The unit 60 comprises a heater 600, a heater holder 601, a support stay 602 and a belt 603.

The heater 600 is a heating member for heating the belt 603, slidably contacting with the inner surface of the belt 603. The heater 600 is pressed to the inside surface of the belt 603 toward the roller 70 so as to provide a desired nip width of the nip N. The dimensions of the heater 600 in this embodiment are 5-20 mm in the width (the dimension as measured in the left-right direction in FIG. 2), 350-400 mm in the length (the dimension measured in the front-rear direction in FIG. 2), and 0.5-2 mm in the thickness. The heater 600 comprises a substrate 610 elongated in a direction perpendicular to the feeding direction of the sheet P (widthwise direction of the sheet P), and a heat generating resistor 620 (heat generating element 620).

The heater 600 is fixed on the lower surface of the heater holder 601 along the longitudinal direction of the heater holder 601. In this embodiment, the heat generating element 620 is provided on the back side of the substrate 610 which is not in slidable contact with the belt 603, but the heat generating element 620 may be provided on the front surface of the substrate 610 which is in slidable contact with the belt 603. However, the heat generating element 620 is preferably provided on the back side of the substrate 610, by which uniform heating effect to the substrate 610 is accomplished, from the standpoint of preventing non-uniform heat application which may be caused by a non-heat generating portion of the heat generating element 620. The details of the heater 600 will be described hereinafter.

The belt 603 is a cylindrical (endless) belt (film) for heating the image on the sheet in the nip N. The belt 603 comprises a base material 603a, an elastic layer 603b thereon, and a parting layer 603c on the elastic layer 603b, for example. The base material 603a may be made of metal material such as stainless steel or nickel, or a heat resistive resin material such as polyimide. The elastic layer 603b may be made of an elastic and heat resistive material such as a silicone rubber or a fluorine-containing rubber. The parting layer 603c may be made of fluorinated resin material or silicone resin material.

The belt 603 of this embodiment has dimensions of approx. 30 mm in the outer diameter, approx. 330 mm in the length (the dimension measured in the front-rear direction in FIG. 2), approx. 30 μm in the thickness, and the material of the base material 603a is nickel. The silicone rubber elastic layer 603b having a thickness of approx. 400 μm is formed on the base material 603a, and a fluorine resin tube (parting layer 603c) having a thickness of approx. 20 μm coats the elastic layer 603b.

The belt contacting surface of the substrate 610 may be provided with a polyimide layer having a thickness of approx. 10 μm as a sliding layer 603d. When the polyimide layer is provided, the rubbing resistance between the fixing belt 603 and the heater 600 is low, and therefore, the wearing of the inner surface of the belt 603 can be suppressed. In order to further enhance the slidability, a lubricant such as grease may be applied to the inner surface of the belt.

The heater holder 601 (holder 601) functions to hold the heater 600 in the state of urging the heater 600 toward the inner surface of the belt 603. The holder 601 has a semi-arcuate cross-section (the surface of FIG. 2) and functions to regulate a rotation orbit of the belt 603. The holder 601 may be made of heat resistive resin material or the like. In this embodiment, it is Zenite 7755 (tradename) available from Dupont.

The support stay 602 supports the heater 600 by way of the holder 601. The support stay 602 is preferably made of a material which is not easily deformed even when a high pressure is applied thereto, and in this embodiment, it is made of SUS304 (stainless steel).

As shown in FIG. 3, the support stay 602 is supported by left and right flanges 411a and 411b at the opposite end portions with respect to the longitudinal direction. The flanges 411a and 411b may be simply called flange 411. The flange 411 regulates the movement of the belt 603 in the longitudinal direction and the circumferential direction configuration of the belt 603. The flange 411 is made of heat resistive resin material or the like. In this embodiment, it is PPS (polyphenylenesulfide resin material).

Between the flange 411a and a pressing arm 414a, an urging spring 415a is compressed. Also, between a flange 411b and a pressing arm 414b, an urging spring 415b is compressed. The urging springs 415a and 415b may be simply called urging spring 415. With such a structure, an elastic force of the urging spring 415 is applied to the heater 600 through the flange 411 and the support stay 602. The belt 603 is pressed against the upper surface of the roller 70 at a predetermined urging force to form the nip N having a predetermined nip width. In this embodiment, the pressure is approx. 156.8 N at one end portion side and approx. 313.6 N (32 kgf) in total.

As shown in FIG. 3, a connector 700 is provided as an electric energy supply member electrically connected with the heater 600 to supply the electric power to the heater 600. The connectors 700a, 700b may be simply called connector 700. The connector 700 is detachably provided at one longitudinal end portion of the heater 600. The connector 700 is detachably provided at the other longitudinal end portion of the heater 600. The connector 700 is easily detachably mounted to the heater 600, and therefore, assembling of the fixing device 40 and the exchange of the heater 600 or belt 603 upon damage of the heater 600 is easy, thus providing good maintenance property. Details of the connector 700 will be described hereinafter.

As shown in FIG. 2, the roller 70 is a nip forming member which contacts an outer surface of the belt 603 to cooperate with the belt 603 to form the nip N. The roller 70 has a multi-layer structure on the core metal of metal material, the multi-layer structure including an elastic layer 72 on the core metal 71 and a parting layer 73 on the elastic layer 72. Examples of the materials of the core metal 71 include SUS (stainless steel), SUM (sulfur and sulfur-containing free-machining steel), Al (aluminum) or the like. Examples of the materials of the elastic layer 72 include an elastic solid rubber layer, an elastic foam rubber layer, an elastic porous rubber layer or the like. Examples of the materials of the parting layer 73 include fluorinated resin material.

The roller 70 of this embodiment includes a core metal of steel, an elastic layer 72 of silicone rubber foam on the core metal 71, and a parting layer 73 of fluorine resin tube on the elastic layer 72. Dimensions of the portion of the roller 70 having the elastic layer 72 and the parting layer 73 are approx. 25 mm in outer diameter, and approx. 330 mm in length.

A thermister 630 is a temperature sensor provided on a back side of the heater 600 (opposite side from the sliding surface side. The thermister 630 is bonded to the heater 600 in the state that it is insulated from the heat generating element 620. The thermister 630 has a function of detecting a temperature of the heater 600. As shown in FIG. 5, the thermister 630 is connected with a control circuit 100 through an A/D converter (unshown) and feed an output corresponding to the detected temperature to the control circuit 100.

The control circuit 100 comprises a circuit including a CPU operating for various controls, a non-volatilization medium such as a ROM storing various programs. The programs are stored in the ROM, and the CPU reads and execute them to effect the various controls. The control circuit 100 may be an integrated circuit such as ASIC if it is capable of performing the similar operation.

As shown in FIG. 5, the control circuit 100 is electrically connected with the voltage source 110 so as to control is electric power supply from the electric energy supply circuit 110. The control circuit 100 is electrically connected with the thermister 630 to receive the output of the thermister 630.

The control circuit 100 uses the temperature information acquired from the thermister 630 for the electric power supply control for the electric energy supply circuit 110. More particularly, the control circuit 100 controls the electric power to the heater 600 through the electric energy supply circuit 110 on the basis of the output of the thermister 630. In this embodiment, the control circuit 100 carries out a wave number control of the output of the electric energy supply circuit 110 to adjust an amount of heat generation of the heater 600. By such a control, the heater 600 is maintained at a predetermined temperature (approx. 180 degree C., for example).

As shown in FIG. 3, the core metal 71 of the roller 70 is rotatably held by bearings 41a and 41b provided in a rear side and a front side of the side plate 41, respectively. One axial end of the core metal is provided with a gear G to transmit the driving force from a motor M to the core metal 71 of the roller 70. As shown in FIG. 2, the roller 70 receiving the driving force from the motor M rotates in the direction indicated by the arrow (clockwise direction). In the nip N, the driving force is transmitted to the belt 603 by the way of the roller 70, so that the belt 603 is rotated in the direction indicated by the arrow (counterclockwise direction).

The motor M is a driving portion for driving the roller 70 through the gear G. As shown in FIG. 5, the control circuit 100 is electrically connected with the motor M to control the electric power supply to the motor M. When the electric energy is supplied by the control of the control circuit 100, the motor M starts to rotate the gear G.

The control circuit 100 controls the rotation of the motor M. The control circuit 100 rotates the roller 70 and the belt 603 using the motor M at a predetermined speed. It controls the motor so that the speed of the sheet P nipped and fed by the nip N in the fixing process operation is the same as a predetermined process speed (approx. 200 [mm/sec], for example).

### [Heater]

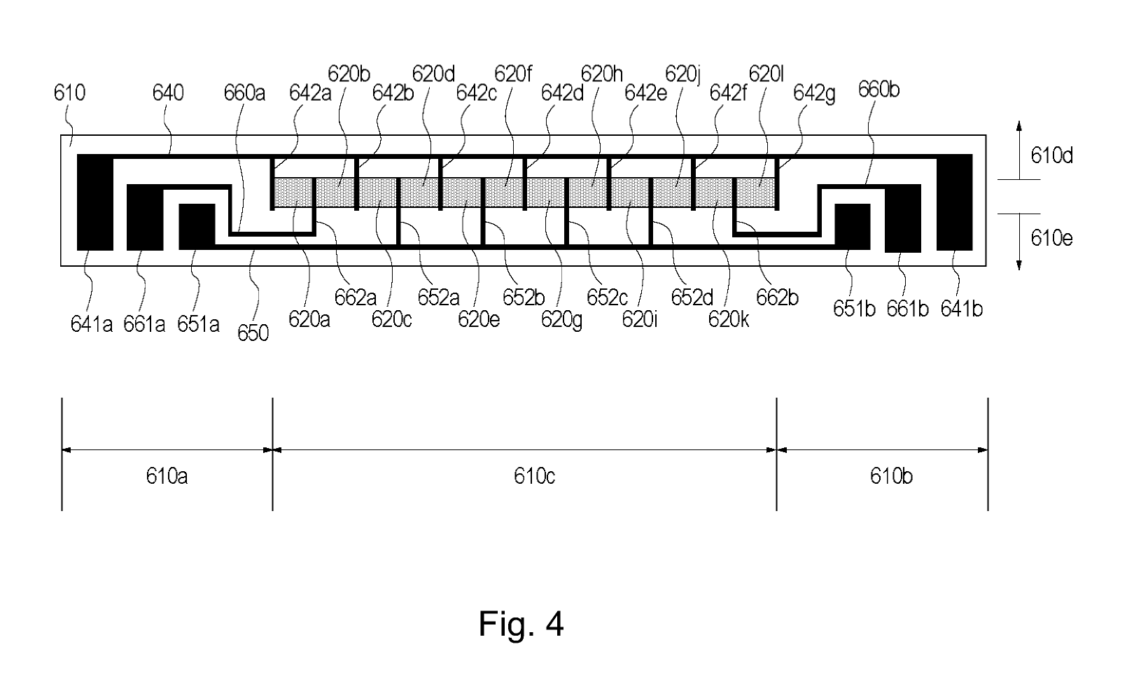

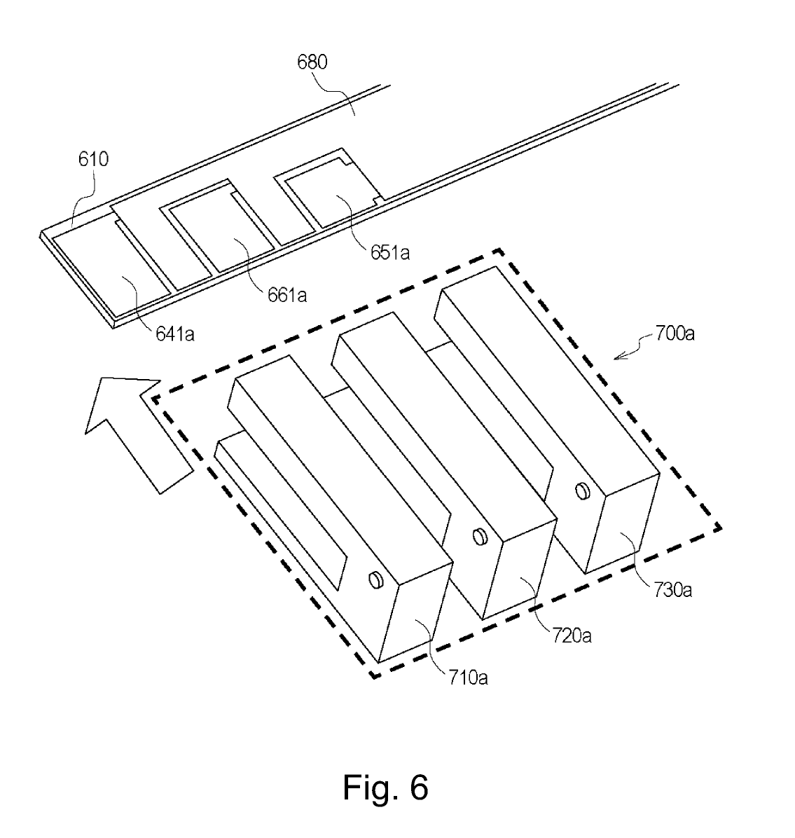

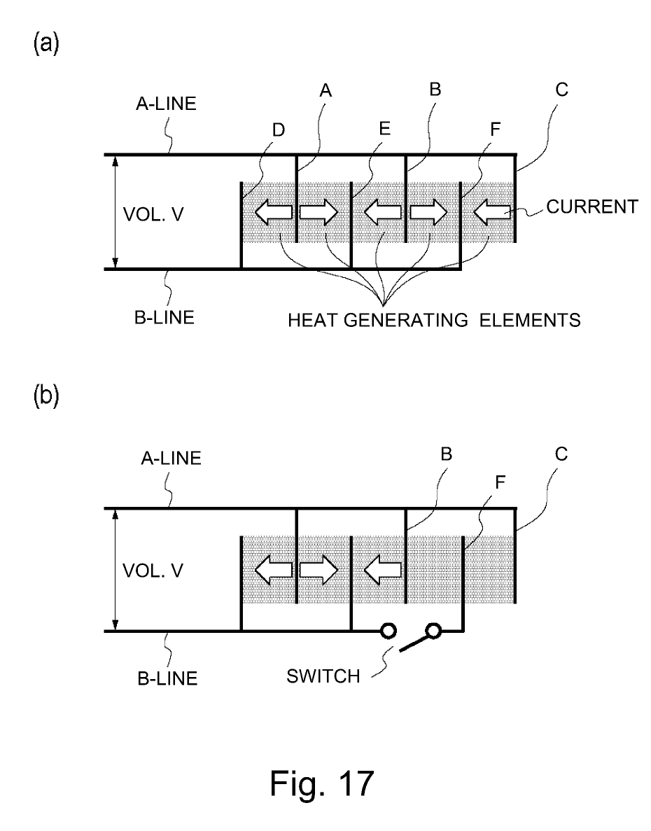

The structure of the heater 600 used in the fixing device 40 will be described in detail. FIG. 4 illustrates a structure of a heater Embodiment 1. FIG. 6 illustrates a connector. Part (a) of FIG. 17 illustrates a heat generating type used in the heater 600. Part (b) of FIG. 17 illustrates a heat generating region switching type used with the heater 600.

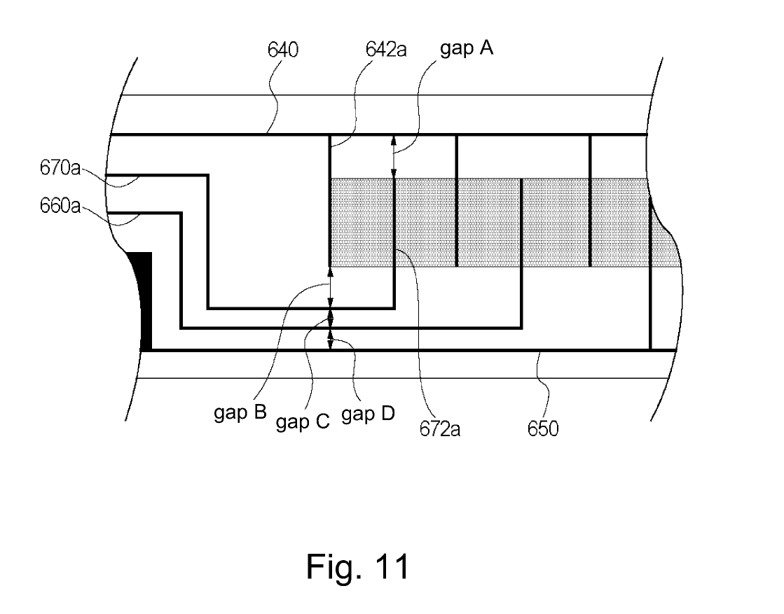

The heater 600 of this embodiment is a heater using the heat generating type shown in parts (a) and (b) of FIG. 11. As shown in part (a) of FIG. 17, electrodes A-C are electrically connected with the A-electroconductive-line, and electrodes D-F are electrically connected with B-electroconductive-line. The electrodes connected with the A-electroconductive-lines and the electrodes connected with the B-electroconductive-lines are interlaced (alternately arranged) along the longitudinal direction (left-right direction in part (a) of FIG. 11), and heat generating elements are electrically connected between the adjacent electrodes. When a voltage V is applied between the A-electroconductive-line and the B-electroconductive-line, a potential difference is generated between the adjacent electrodes. As a result, electric currents flow through the heat generating elements, and the directions of the electric currents through the adjacent heat generating elements are opposite to each other. In this type heater, the heat is generated in the above-described the manner. As shown in part (b) of FIG. 17, between the B-electroconductive-line and the electrode F, a switch or the like is provided, and when the switch is opened, the electrode B and the electrode C are at the same potential, and therefore, no electric current flows through the heat generating element therebetween. In this system, the heat generating elements arranged in the longitudinal direction are independently energized so that only a part of the heat generating elements can be energized by switching a part off. In other words, in the system, the heat generating region can be changed by providing switch or the like in the electroconductive line. In the heater 600, the heat generating region of the heat generating element 620 can be changed using the above-described system.

The heat generating element generates heat when energized, irrespective of the direction of the electric current, but it is preferable that the heat generating elements and the electrodes are arranged so that the currents flow along the longitudinal direction. Such an arrangement is advantageous over the arrangement in which the directions of the electric currents are in the widthwise direction perpendicular to the longitudinal direction (up-down direction in part (a) of FIG. 11) in the following point. When joule heat generation is effected by the electric energization of the heat generating element, the heat generating element generates heat correspondingly to the resistance value thereof, and therefore, the dimension and the material of the heat generating element are selected in accordance with the direction of the electric current so that the resistance value is at a desired level. The dimension of the substrate on which the heat generating element is provided is very short in the widthwise direction as compared with that in the longitudinal direction. Therefore, if the electric current which flows in the widthwise direction, it is difficult to provide the heat generating element with a desired resistance value, using a low resistance material. On the other hand, when the electric current flows in the longitudinal direction, it is relatively easy to provide the heat generating element with a desired resistance value, using the low resistance material. In the case that in heat generating element is made of a high resistance material, temperature non-uniformity may result because of thickness unevenness of the heat generating element. For example, when the heat generating element material is applied on the substrate along the longitudinal direction by screen printing or like, a thickness non-uniformity of about 5% may result in the widthwise direction. This is because a heat generating element material painting non-uniformity occurs due to a small pressure difference in the widthwise direction by a painting blade. For this reason, it is preferable that the heat generating elements and the electrodes are arranged so that the electric currents flow in the longitudinal direction.

In the case that the electric power is supplied individuality to the heat generating elements arranged in the longitudinal direction, it is preferable that the electrodes and the heat generating elements are disposed such that the directions of the electric current flow alternates between adjacent ones. As to the arrangements of the heat generating members and the electrodes, it would be considered to arrange the heat generating elements each connected with the electrodes at the opposite ends thereof, in the longitudinal direction, and the electric power is supplied in the longitudinal direction. However, with such an arrangement, two electrodes are provided between adjacent heat generating elements, with the result of the likelihood of short circuit. In addition, the number of required electrodes is large with the result of large non-heat generating portion. Therefore, it is preferable to arrange the heat generating elements and the electrodes such that an electrode is made common between adjacent heat generating elements. With such an arrangement, the likelihood of the short circuit between the electrodes can be avoided, and the non-heat generating portion can be made small.

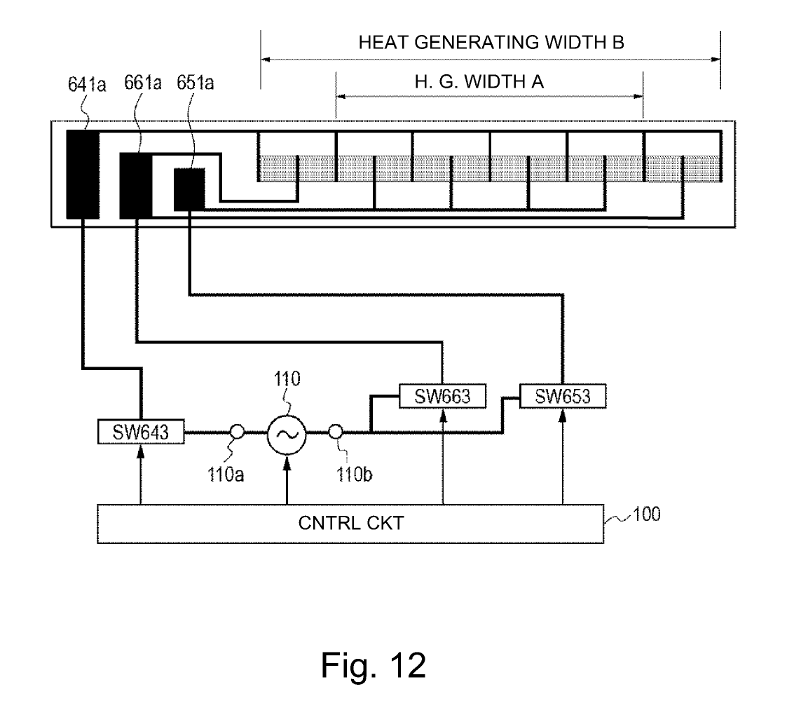

In this embodiment, a common electroconductive line 640 corresponds to A-electroconductive-line of part (a) of FIG. 12, and opposite electroconductive lines 650, 660a, 660b correspond to B-electroconductive-line. In addition, common electrodes 652a-652g correspond to electrodes A-C of part (a) of FIG. 12, and opposite electrodes 652a-652d, 662a, 662b correspond to electrodes D-F. Heat generating elements 620a-620l correspond to the heat generating elements of part (a) of FIG. 17. Hereinafter, the common electrodes 642a-642g are simply common electrode 642. The opposite electrodes 652a-652e are simply called opposite electrode 652. The opposite electrodes 652a-652e are simply called opposite electrode 652. The opposite electroconductive lines 660a, 660b are simply called opposite electroconductive line 660. The heat generating elements 620a-620l are simply called heat generating element 620. The structure of the heater 600 will be described in detail referring to the accompanying drawings.

As shown in FIGS. 4 and 6, the heater 600 comprises the substrate 610, the heat generating element 620 on the substrate 610, an electroconductor pattern (electroconductive line), and an insulation coating layer 680 covering the heat generating element 620 and the electroconductor pattern.

The substrate 610 determines the dimensions and the configuration of the heater 600 and is contactable to the belt 603 along the longitudinal direction of the substrate 610. The material of the substrate 610 is a ceramic material such as alumina, aluminum nitride or the like, which has high heat resistivity, thermo-conductivity, electrical insulative property or the like. In this embodiment, the substrate is a plate member of alumina having a length (measured in the left-right direction in FIG. 4) of approx. 400 mm, a width (up-down direction in FIG. 4) of approx. 10 mm and a thickness of approx. 1 mm.

On the back side of the substrate 610, the heat generating element 620 and the electroconductor pattern (electroconductive line) are provided through thick film printing method (screen printing method) using an electroconductive thick film paste. In this embodiment, a silver paste is used for the electroconductor pattern so that the resistivity is low, and a silver-palladium alloy paste is used for the heat generating element 620 so that the resistivity is high. As shown in FIG. 6, the heat generating element 620 and the electroconductor pattern coated with the insulation coating layer 680 of heat resistive glass so that they are electrically protected from leakage and short circuit.

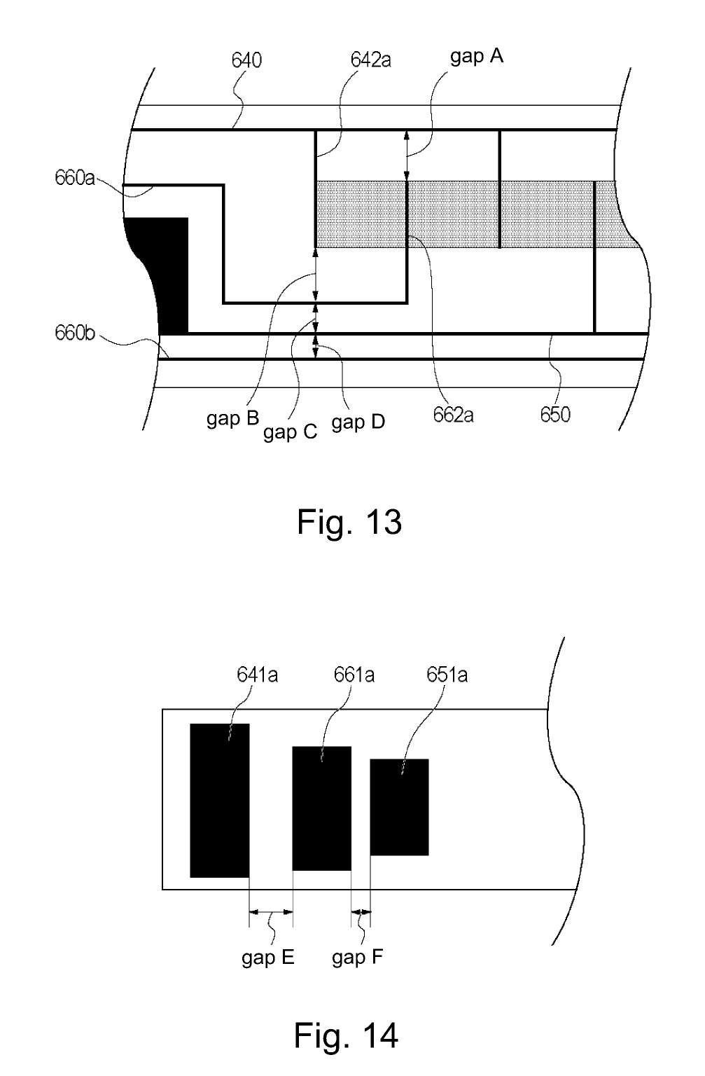

As shown in FIG. 13, a one longitudinal end portion 610a of the substrate 610 is provided with electrical contacts 1641, 1651, 1661, 1671 as a part of the electroconductor pattern. The other end portion side 610b of the substrate 610 is provided with the electrical contacts 641b, 651b, and 661b as a part of the electroconductor pattern. A longitudinally central region 610c of the substrate 610 is provided with the heat generating element 620 and common electrodes 642a-642g and opposite electrodes 652a-652e, 662a-662b as a part of the electroconductor pattern. In one end portion side 610d of substrate 610 beyond the heat generating element 620 with respect to the widthwise direction, the common electroconductive line 640 as a part of the electroconductor pattern is provided. In the other end portion side 610e of the substrate 610 beyond the heat generating element 620 with respect to the widthwise direction, the opposite electroconductive lines 650 and 660 are provided as a part of the electroconductor pattern.

The heat generating elements 620 (620a-620l) are resistors for generating joule heat upon electric power supply thereto. The heat generating element 620 is one heat generating element member extending in the longitudinal direction on the substrate 610, and is disposed in the region 610c (FIG. 4) adjacent to the center portion of the substrate 610. The heat generating element 620 has a width (widthwise direction of the substrate 610) of 1-4 mm and a thickness of 5-20 μm, and it has a predetermined resistance value. The heat generating element 620 in this embodiment has the width of approx. 2 mm and the thickness of approx. 10 μm. A total length of the heat generating element 620 in the longitudinal direction is approx. 320 mm, which is enough to cover a width of the A4 size sheet P (approx. 297 mm in width).

On the heat generating element 620, seven common electrodes 642a-642g which will be described hereinafter are laminated with intervals in the longitudinal direction. In other words, the heat generating element 620 is isolated into six sections by common electrodes 642a-642g along the longitudinal direction. The lengths measured in the longitudinal direction of the substrate 610 of each section are approx. 53.3 mm. On central portions of the respective sections of the heat generating element 620, one of the six opposite electrodes 652, 662 (652a-652d, 662a, 662b) are laminated. In this manner, the heat generating element 620 is divided into 12 sub-sections. The heat generating element 620 divided into 12 sub-sections can be deemed as a plurality of heat generating elements 620a-620l. In other words, the heat generating elements 620a-620l electrically connect adjacent electrodes with each other. Lengths of the sub-section measured in the longitudinal direction of the substrate 610 are approx. 26.7 mm. Resistance values of the sub-section of the heat generating element 620 with respect to the longitudinal direction are approx. 120Ω. With such a structure, the heat generating element 620 is capable of generating heat in a partial area or areas with respect to the longitudinal direction.

The resistivities of the heat generating elements 620 with respect to the longitudinal direction are uniform, and the heat generating elements 620a-620l have substantially the same dimensions. Therefore, the resistance values of the heat generating elements 620a-620l are substantially equal. When they are supplied with electric power in parallel, the heat generation distribution of the heat generating element 620 is uniform. However, it is not inevitable that the heat generating elements 620a-620l have substantially the same dimensions and/or substantially the same resistivities. For example, the resistance values of the heat generating elements 620a and 620l may be adjusted so as to prevent temperature lowering at the longitudinal end portions of the heat generating element 620. At the positions of the heat generating element 620 where the common electrode 642 and the opposite electrode 652, 662 are provided, the heat generation of the heat generating element 620 is substantially zero. However, the heat uniforming function of the substrate 610 makes the influence on the fixing process negligible if the width of the electrode is not more than 1 mm, for example. In this embodiment, the width of each electrode is not more than 1 mm.

The common electrodes 642 (642a-642g) as a first electrode are a part of the above-described electroconductor pattern. The common electrode 642 extends in the widthwise direction of the substrate 610 perpendicular to the longitudinal direction of the heat generating element 620. In this embodiment, the common electrode 642 is laminated on the heat generating element 620. The common electrodes 642 are odd-numbered electrodes of the electrodes connected to the heat generating element 620, as counted from a one longitudinal end of the heat generating element 620. The common electrode 642 is connected to one contact 110a of the voltage source 110 through the common electroconductive line 640 which will be described hereinafter.

The opposite electrodes 652, 662 as a second electrode are a part of the above-described electroconductor pattern. The opposite electrodes 652, 662 extend in the widthwise direction of the substrate 610 perpendicular to the longitudinal direction of the heat generating element 620. The opposite electrodes 652, 662 are laminated on the heat generating element 620. The opposite electrodes 652, 662 are the other electrodes of the electrodes connected with the heat generating element 620 other than the above-described common electrode 642. That is, in this embodiment, they are even-numbered electrodes as counted from the one longitudinal end of the heat generating element 620.

That is, the common electrode 642 and the opposite electrodes 662, 652 are alternately arranged along the longitudinal direction of the heat generating element. The opposite electrodes 652, 662 are connected to the other contact 110b of the electric energy supply circuit 110 through the opposite electroconductive lines 650, 660 which will be described hereinafter.

The common electrode 642 and the opposite electrode 652, 662 function as electrode portions for supplying the electric power to the heat generating element 620.

In this embodiment, the odd-numbered electrodes are common electrodes 642, and the even-numbered electrodes are opposite electrodes 652, 662, but the structure of the heater 600 is not limited to this example. For example, the even-numbered electrodes may be the common electrodes 642, and the odd-numbered electrodes may be the opposite electrodes 652, 662.

In addition, in this embodiment, four of the all opposite electrodes connected with the heat generating element 620 are the opposite electrode 652. In this embodiment, two of the all opposite electrodes connected with the heat generating element 620 are the opposite electrode 662. However, the allotment of the opposite electrodes is not limited to this example, but may be changed depending on the heat generation widths of the heater 600. For example, two may be the opposite electrode 652, and four maybe the opposite electrode 662.

The common electroconductive line 640 as a first electroconductive line is a part the above-described electroconductor pattern. The common electroconductive line 640 extends along the longitudinal direction of the substrate 610 toward the opposite ends (610a, 610b) of substrate 610 in the one end portion side 610d of the substrate. The common electroconductive line 640 is connected with the common electrodes 642 (642a-642g) which is in turn connected with the heat generating element 620 (620a-620l). The opposite end portions of the common electroconductive line 640 is connected to the electrical contact the (641a, 641b) which will be described hereinafter, respectively.

The opposite electroconductive line 650 as a second electroconductive line is a part of the above-described electroconductor pattern. The opposite electroconductive line 650 extends along the longitudinal direction of the substrate 610 toward the opposite end portions (610a, 610b), in the other end portion side 610e of the substrate. The opposite electroconductive line 650 is connected with the opposite electrode 652 (652a-652d) connected to the heat generating element 620. The opposite end portions of the opposite electroconductive line 650 are connected with the electrical contacts 651 (651a, 651b) which will be described hereinafter.

The opposite electroconductive line 660 (660a, 660b) is a part of the above-described electroconductor pattern. The opposite electroconductive line 660a as a third electroconductive line extends along the longitudinal direction of the substrate 610 toward the one end portion side of the substrate, in the other end portion side 610e of the substrate. The opposite electroconductive line 660a is connected with the opposite electrode 662a which is in turn connected with the heat generating element 620 (620a, 620b). The opposite electroconductive line 660 is connected to the electrical contact 661a which will be described hereinafter. The opposite electroconductive line 660b as a fourth electroconductive line extends along the longitudinal direction of the substrate 610 toward the other end portion side 610b of the substrate, in the other end portion side 610e of the substrate. The opposite electroconductive line 660b is connected with the opposite electrode 662b which is in turn connected with the heat generating element 620 (620k, 620l). The opposite electroconductive line 660b is connected to the electrical contact 651b which will be described hereinafter.

The electrical contact 641 (641a, 641b), 651 (651a, 651b), 661 (661a, 661b) are a part of the above-described electroconductor pattern. The electrical contacts 641a, 651a, 661a, are disposed in the one end portion side 610a of the substrate beyond the heat generating element 620 with gaps of approx. 4 mm in the longitudinal direction of the substrate 610. The electrical contacts 641b, 651b, 661b are arranged in the other end portion side 610b of the substrate with a gap of approx. 4 mm in the longitudinal direction. Each of the electrical contacts 641, 651, 661 preferably has a area of not less than 2.5 mm×2.5 mm in order to assure the reception of the electric power supply from the connector 700 which will be described hereinafter. In this embodiment, the of the electrical contacts 641, 651, 661 has a length approx. 3 mm measured in the longitudinal direction of the substrate 610 and a width of not less than 2.5 mm measured in the widthwise direction of the substrate 610. The electrical contacts 641a, 651a, 661a, are disposed in the one end portion side 610a of the substrate beyond the heat generating element 620 with gaps of approx. 4 mm in the longitudinal direction of the substrate 610. The electrical contacts 641b, 651b, 661b are arranged in the other end portion side 610b of the substrate beyond the heat generating element 620 with a gap of approx. 4 mm in the longitudinal direction of the substrate 610. As shown in FIG. 6, no insulation coating layer 680 is provided at the positions of the electrical contacts 641, 651, 661 so that the electrical contacts are exposed. Therefore, the electrical contacts 641, 651, 661 can be electrically connected with the connector 700.

When voltage is applied between the electrical contact 641 and the electrical contact 651 through the connection between the heater 600 and the connector 700, a potential difference is produced between the common electrode 642 (642b-642f) and the opposite electrode 652 (652a-652d). Therefore, through the heat generating elements 620c, 620d, 620e, 620f, 620g, 620h, 620i, 620j, the currents flow along the longitudinal direction of the substrate 610, the directions of the currents through the adjacent heat generating elements being substantially opposite to each other. The heat generating elements 620c, 620d, 620e, 620f, 620g, 620h, 620i as a first heat generating region generate heat, respectively.

When voltage is applied between the electrical contact 641 and the electrical contact 661a through the connection between the heater 600 and the connector 700, a potential difference is produced between the common electrode 642a-642b) and the opposite electrode 662a. Therefore, through the heat generating elements 620a, 620b, the currents flow along the longitudinal direction of the substrate 610, the directions of the currents through the adjacent heat generating elements being substantially opposite to each other. The heat generating elements 620a, 620b as a second heat generating region adjacent the first heat generating region generate heat.

When voltage is applied between the electrical contact 641 and the electrical contact 661b through the connection between the heater 600 and the connector 700, a potential difference is produced between the common electrode 642f and 642g and the opposite electrode 662b through the common electroconductive line 640 and the opposite electroconductive line 660b. Therefore, through the heat generating elements 620k, 620l, the currents flow along the longitudinal direction of the substrate 610, the directions of the currents through the adjacent heat generating elements being substantially opposite to each other. By this, the heat generating elements 620k, 620l as a third heat generating region adjacent to the first heat generating region generate heat.

In this manner, by selecting the electrical contacts supplied with the voltage, the desired one or ones of the heat generating elements 620a-620l can be selectively energized.

### [Connector]

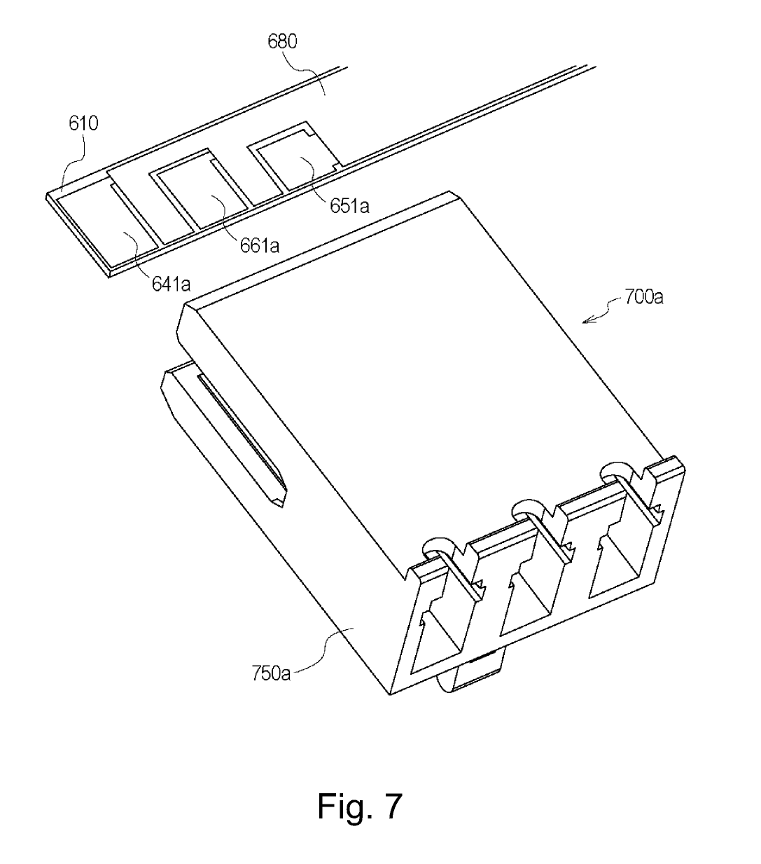

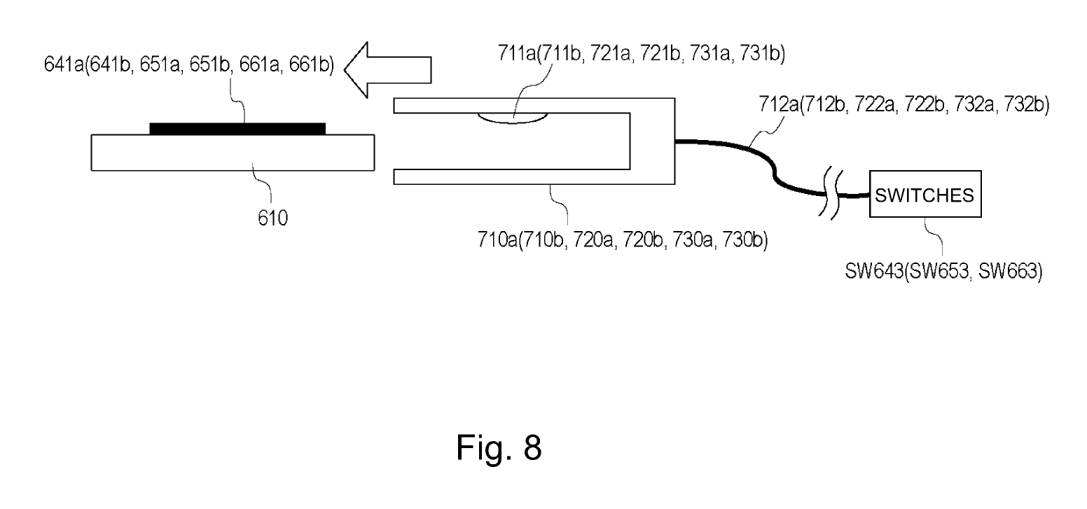

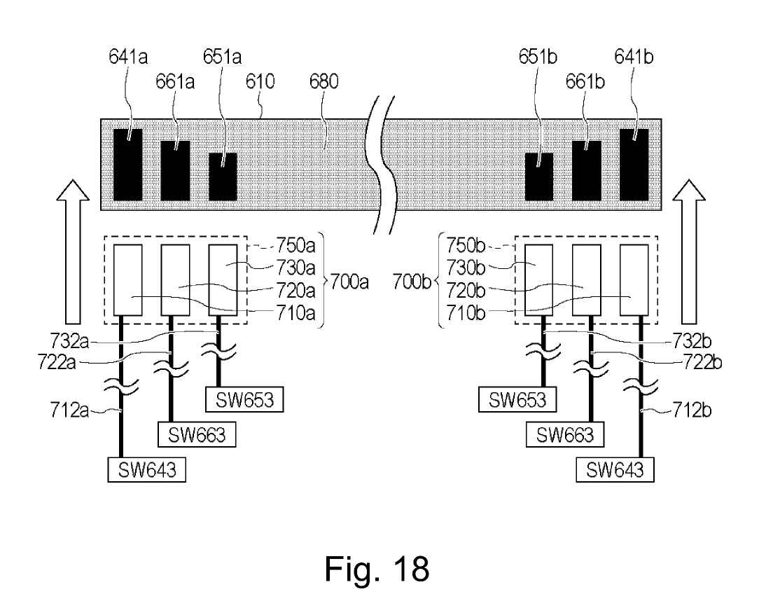

The connector 700 used with the fixing device 40 will be described in detail. FIG. 7 is an illustration of a housing 750. FIG. 8 is an illustration of a contact terminal 710. FIG. 18 is an illustration of mounting method of the connector 700 to the heater 600. The connectors 700a and 700b of this embodiment are provided with contact terminals (which may be called terminal) 710a, 710b, 720a, 720b, 730a, 730b, and are electrically connected with the heater 600 by being mounted to the heater 600. More particularly, the connector 700a is provided with a terminal 710a electrically connectable with the electrical contact 641a, a terminal 720a electrically connectable with the electrical contact 661a, and a terminal 730a electrically connectable with the electrical contact 651a. The connector 700b is provided with a terminal 710b electrically connectable with the electrical contact 641b, a terminal 720b electrically connectable with the electrical contact 661b, and a terminal 730b electrically connectable with the electrical contact 651b. By the connectors 700a, 700b being mounted to the heater 600 to sandwich the heater 600, the terminals are connected with the corresponding electrical contacts. In the fixing device 40 of this embodiment having the above-described the structures, no soldering or the like is used for the electrical connection between the connectors and the electrical contacts. Therefore, the electrical connection between the heater 600 and the connector 700 which rise in temperature during the fixing process operation can be accomplished and maintained with high reliability. In the fixing device 40 of this embodiment, the connector 700 is detachably mountable relative to the heater 600, and therefore, the belt 603 and/or the heater 600 can be replaced without difficulty. The structure of the connector 700 will be described in detail.

As shown in FIG. 18, the connector 700a provided with the terminal 710a, 720a, 730a of metal is mounted to the heater 600 from the end portion of the substrate 610 with respect to the widthwise direction, in the one end portion side 610a of the substrate. The connector 700b provided with the terminals 710b, 720b, 730 is mounted to the heater 600 from the end portion of the substrate 610 with respect to the widthwise direction, in the other end portion side 610b of the substrate.

The terminals 710, 720, 730 will be described taking the terminal 710a as an example. As shown in FIG. 8, the terminal 710a functions to electrically connect the electrical contact 641a and the switch SW643 which will be described hereinafter. The contact terminal 710a is provided with the electrical contact 711a for contacting to the electrical contact 641 and a cable 712a for the electrical connection with the switch SW643. The contact terminal 710a has a channel-like configuration, and by moving in the direction indicated by an arrow in FIG. 8, it can receive the heater 600. The portion of the connector 700a which contacts the electrical contact 641a is provided with the electrical contact 711a which contacts the electrical contact 641a, by which the electrical connection is established between the electrical contact 641a and the contact terminal 710a. The electrical contact 711a has a leaf spring property, and therefore, contacts the electrical contact 641a while pressing against it. Therefore, the contact 710 sandwiches the heater 600 between the front and back sides to fix the position of the heater 600.

Similarly, the contact terminal 710b functions to contact the electrical contact 641b with the switch SW643 which will be described hereinafter. The contact terminal 710b is provided with the electrical contact 711b for contacting to the electrical contact 641b and a cable 712b for the electrical connection with the switch SW643.

Similarly, the contact terminal 720 (720a, 720b) functions to contact the electrical contact 661 (661a, 661b) with the switch SW663 which will be described hereinafter. The contact terminal 720 (720a, 720b) is provided with the electrical contacts 721a, 721b for contacting to the electrical contact 661 and a cable 722a, 722b for the electrical connection with the switch SW663.

Similarly, the contact terminal 730 (730a, 730b) functions to contact the electrical contact 651 (651a, 651b) which will be described hereinafter. The contact terminal 730 (730a, 730b) is provided with the electrical contacts 731a, 731b for contacting to the electrical contact 651 and a cable 731a, 732b for the electrical connection with the switch SW653.

As shown in FIG. 7, the terminals 710a, 720a, 730a of metal is integral is supported by a housing 750a of resin material. The terminals 710a, 720a, 730a are disposed in the housing 750a with gaps between adjacent ones so as to connect with the electrical contacts 641a, 661a, and 651a when the connector 700a is mounted to the heater 600. Between the terminals, a partition is provided to assure the electrical insulation between the terminals.

The terminals 710b, 720b, 730b of metal are supported by the housing 750a of the resin material. The terminal 710a, 720a, 730a are disposed with a gap therebetween in the housing 750b so as to contact with the electrical contacts 641b, 661b, 651b, respectively, when the connector 700b is mounted to the heater. Between the terminals, a partition is provided to assure the electrical insulation between the terminals.

In this embodiment, the connector 700 is mounted in the widthwise direction of the substrate 610, but this mounting method is not limiting to the present invention. For example, the structure may be such that the connector 700 is mounted in the longitudinal direction of the substrate.

### [Electric Energy Supply to Heater]

An electric energy supply method to the heater 600 will be described. The fixing device 40 of this embodiment is capable of changing a width of the heat generating region of the heater 600 by controlling the electric energy supply to the heater 600 in accordance with the width size of the sheet P. In the fixing device 40 of this embodiment, the sheet P is fed with the center of the sheet P aligned with the center of the fixing device 40, and therefore, the heat generating region extend from the center portion. The electric energy supply to the heater 600 will be described in conjunction with the accompanying drawings.

The electric energy supply circuit 110 is a circuit for supplying the electric power to the heater 600. In this embodiment, the commercial voltage source (AC voltage source) of approx. 100V in effective value (single phase AC). The electric energy supply circuit 110 of this embodiment is provided with a voltage source contact 110a and a voltage source contact 110b having different electric potential. The electric energy supply circuit 110 may be DC voltage source if it has a function of supplying the electric power to the heater 600.

As shown in FIG. 5, the control circuit 100 is electrically connected with switch SW643, switch SW653, and switch SW663, respectively to control the switch SW643, switch SW653, and switch SW663, respectively.

Switch SW643 is a switch (relay) provided between the voltage source contact 110a and the electrical contact 641. The switch SW643 connects or disconnects between the voltage source contact 110a and the electrical contact 641 in accordance with the instructions from the control circuit 100. The switch SW653 is a switch provided between the voltage source contact 110b and the electrical contact 651. The switch SW653 connects or disconnects between the voltage source contact 110a and the electrical contact 651 in accordance with the instructions from the control circuit 100. The switch SW663 is a switch provided between the voltage source contact 110b and the electrical contact 661 (661a, 661b). The switch SW663 connects or disconnects between the voltage source contact 110a and the electrical contact 661 (661a, 661b) in accordance with the instructions from the control circuit 100.

When the control circuit 100 receives the execution instructions of a job, the control circuit 100 acquires the width size information of the sheet P to be subjected to the fixing process. In accordance with the width size information of the sheet P, a combination of ON/OFF of the switch SW643, switch SW653, switch SW663 is controlled so that the heat generation width of the heat generating element 620 fits the sheet P. At this time, the control circuit 100, the electric energy supply circuit 110, switch SW643, switch SW653, switch SW663 and the connector 700 functions as an electric energy supplying means for supplying the electric power to the heater 600.

When the sheet P is a large size sheet (an usable maximum width size), that is, when A3 size sheet is fed in the longitudinal direction or when the A4 size is fed in the landscape fashion, the width of the sheet P is approx. 297 mm. Therefore, the control circuit 100 controls the electric power supply to provide the heat generation width B (FIG. 5) of the heat generating element 620. To effect this, the control circuit 100 renders ON all of the switch SW643, switch SW653, switch SW663. As a result, the heater 600 is supplied with the electric power through the electrical contacts 641, 661a, 661b, 651, and all of the 12 sub-sections of the heat generating element 620 generate heat. At this time, the heater 600 generates the heat uniformly over the approx. 320 mm region to meet the approx. 297 mm sheet P.

When the size of the sheet P is a small size (narrower than the maximum width), that is, when an A4 size sheet is fed longitudinally, or when an A5 size sheet is fed in the landscape fashion, the width of the sheet P is approx. 210 mm. Therefore, the control circuit 100 provides a heat generation width A (FIG. 5) of the heat generating element 620. Therefore, the control circuit 100 renders ON the switch SW643, switch SW663 and renders OFF the switch SW653. As a result, the heater 600 is supplied with the electric power through the electrical contacts 641, 651, so that 8 sub-sections of the 12 sub-sections of the heat generating element 620 generate heat. At this time, the heater 600 generates the heat uniformly over the approx. 213 mm region to meet the approx. 210 mm sheet P.

### [Arrangement of Electroconductive Lines]

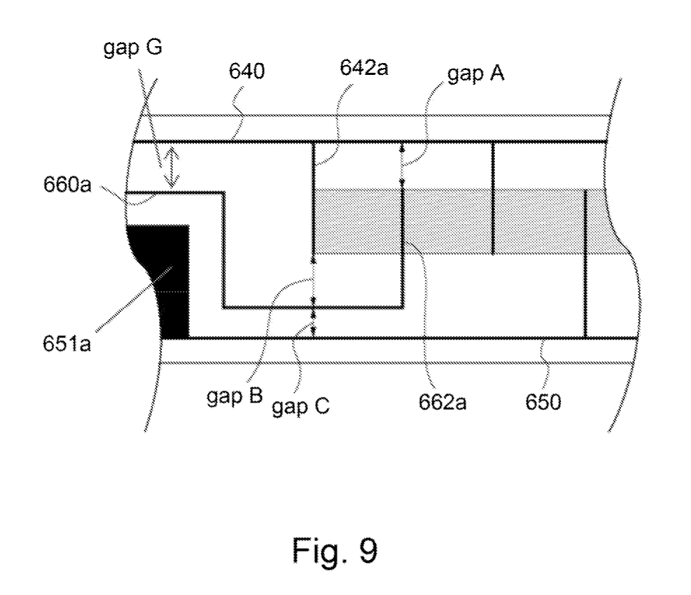

The arrangement of the electroconductive lines on the substrate 610 will be described the fixed. FIG. 9 illustrates the arrangement of the electroconductive lines on the substrate 610. As described hereinbefore, the heater 600 of this embodiment is provided with the common electroconductive line 640 connecting to the voltage source contact 110a in the one end portion side 610d of the substrate. All of the common electrodes 642 are connected with the common electroconductive line 640. On the other hand, the opposite electroconductive lines 650, 660 connecting to the voltage source contact 110b are provided in the other end portion side 610e of the substrate. The opposite electrode 652 is connected with the opposite electroconductive line 650, and the opposite electrode 662a is connected with the opposite electroconductive line 660a, and in addition, the opposite electrode 662b is connected with the opposite electroconductive line 660b. With this structure, electroconductive line the connecting to the different voltage source contacts are not positioned adjacent to each other, and therefore, the possibility of the short circuit between the electroconductive lines can be reduced. Therefore, the gap required to be provided between the electroconductive lines for preventing the short circuit can be reduced, so that the width of the substrate 610 can be reduced. The description will be made in detail in conjunction with the accompanying drawings.

As shown in FIG. 9, the common electroconductive line 640 connected with the common electrode 642 and the electrical contact 641a extends in the longitudinal direction of the substrate 610. More particularly, in the central region 610c of the substrate 610, it is extended substantially in parallel with the heat generating element 620 adjacent thereto. Here, the “substantially parallel” covers the case of not strictly “parallel with” because of the manufacturing tolerances of the electroconductive line formation.

As shown FIG. 9, in the one end portion side 610d of the substrate (FIG. 4), the common electroconductive line 640 is spaced from the heat generating element 620 and the opposite electrode by approx. 400 μm in the widthwise direction of the substrate 610. That is, a gap A of approx. 400 μm is provided between the heat generating element 620 and the common electroconductive line 640. The gap A is provided to assuredly insulate between the common electroconductive line 640 and the opposite electrode (662a, for example), and when the insulation coating layer 680 is provided, the minimum value of the gap is approx. 400 μm. The common electroconductive line 640 and the opposite electrode (662a, for example) are connected to different voltage source contacts (110a and 110b), and therefore, the gap A is relatively larger for safety. For this reason, the gap An is not satisfactory even if it is approx. 400 μm locally, but it is desirable that approx. 400 μm is assured over the entire area in which the heat generating element 620 and the common electroconductive line 640 extend substantially in parallel with each other.

The opposite electroconductive line 660a connecting with the opposite electrode 662a and the electrical contact 661a, and the opposite electroconductive line 660b connecting with the opposite electrode 662b and the electrical contact 661b are extended along the longitudinal direction of the substrate 610. The opposite electroconductive lines 660a, 660b are extended substantially with each other adjacent to the heat generating element 620 in the central region 610c (FIG. 4) of the substrate 610. In this embodiment, the opposite electroconductive lines 660a, 660b are spaced from the heat generating element 620 by approx. 400 μm in the widthwise direction of the substrate 610. That is, a gap B of approx. 400 μm is provided between the heat generating element 620 and the opposite electroconductive line 660. The gap B is provided to assure the insulation between the opposite electroconductive line 660 and the common electrode (642a, for example), and when the insulation coating layer 680 is provided, the minimum value of the gap is approx. 400 μm. The opposite electroconductive line 660 and the opposite electrode (642a, for example) are connected to different voltage source contacts (110a and 110b), and therefore, the gap B is relatively large for safety. For this reason, the gap B is not satisfactory even if it is approx. 400 μm locally, but it is desirable that approx. 400 μm is assured over the entire area in which the heat generating element 620 and the common electroconductive line 640 extend substantially in parallel with each other.

The opposite electroconductive line 650 connecting with the opposite electrode 652, the electrical contact 651a and the electrical contact 651b extends along the longitudinal direction of the substrate 610. More particularly, in the central region 610c of the substrate 610, it is extended in parallel with and adjacent to the opposite electroconductive lines 660a, 660b. In this embodiment, the opposite electroconductive line 650 is spaced from the opposite electroconductive lines 660a, 660b by approx. 100 μm in the widthwise direction of the substrate 610. That is, a gap of approx. 100 μm is provided between the opposite electroconductive line 650 and the opposite electroconductive line 660a, 660b. The gap C is required for arranging the opposite electroconductive line 660 and the opposite electroconductive line 650 as separate electroconductive lines. The opposite electroconductive line 660 and the opposite electroconductive line 650 are connected to the same voltage source contact, and therefore, the gap C may be small. The width of the substrate 610 can be reduced by the amount of reduction of the gap C. For this reason, it will not suffice even if the gap C is less than gap A locally, but it is desirable that the gap C is less than gap A over the entire area in which the opposite electroconductive line 660 and the opposite electroconductive line 650 extend substantially in parallel with each other.

As shown in FIG. 9, in the one end portion side 610a of the substrate (FIG. 4) with respect to the longitudinal direction, the common electroconductive line 640, the opposite electroconductive line 660a and the electrical contact 651a are arranged in the widthwise direction of the substrate. The opposite electroconductive line 660a extends around the electrical contact 651a so as to be connected with the electrical contact 661a provided in the one end portion side of the substrate beyond the electrical contact 651a with respect to the longitudinal direction of the substrate. Here, a gap G between common electroconductive line 640 and the opposite electroconductive line 660a in the widthwise direction of the substrate is approx. 400 μm in this embodiment. The gap G is provided to assure the insulation between the common electroconductive line 640 and the opposite electroconductive line 660a, and when the insulation coating layer 680 is provided, the minimum value of the gap is approx. 400 μm. The common electroconductive line 640 and the opposite electroconductive line 660a are connected with different voltage source contacts (110a and 110b), and therefore, the gap G is relatively large for safety. For this reason, it is not satisfactory even if the gap G is approx. 400 μm locally, but it is desirable that the gap of approx. 400 μm is assured over the entire area in which the common electroconductive line 640 and the opposite electroconductive line 660a extend substantially in parallel with each other.

As described hereinbefore, in this embodiment, the electroconductive lines connecting to the same voltage source contact are adjacent to each other, and therefore, the gap between the electroconductive lines can be reduced. That is, gap G=gap A>gap C (gap B>gap C) are satisfied. Therefore the space required for the electroconductive lines on the substrate 610 can be reduced, and the upsizing of the substrate 610 attributable to the provision of the electroconductive lines on the substrate can be suppressed. Therefore, the manufacturing cost of the heater 600 can be reduced.

### Embodiment 2

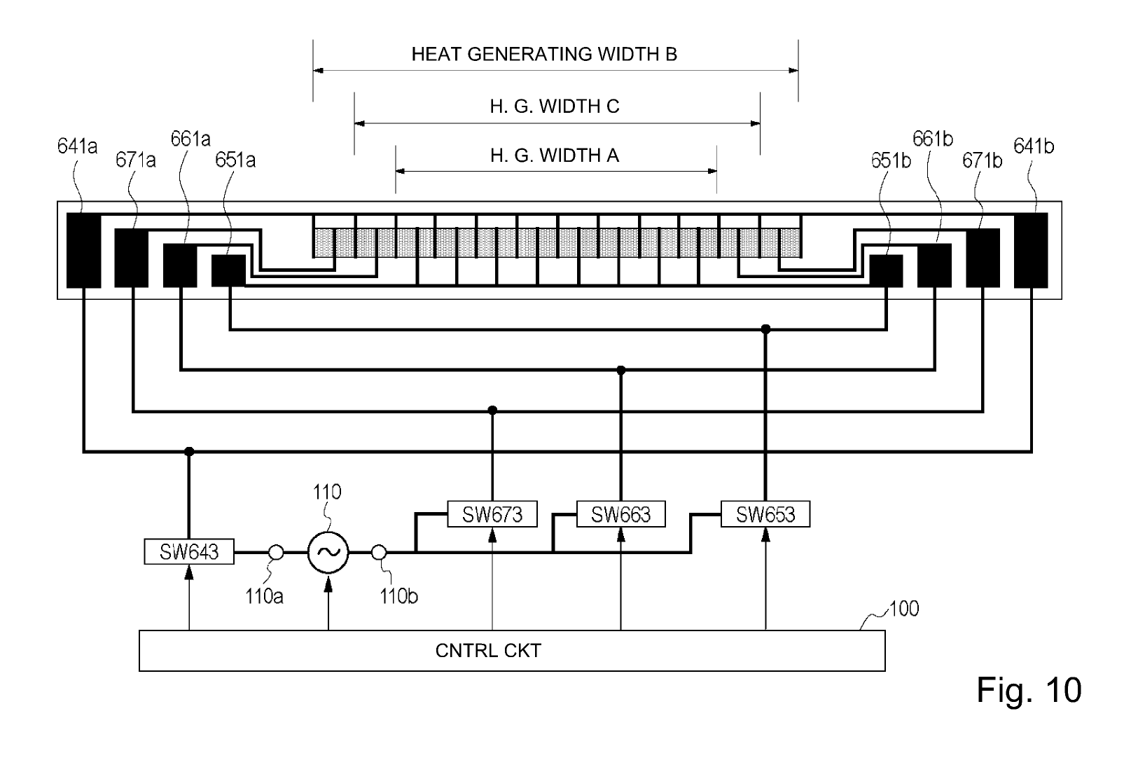

A heater 600 according to Embodiment 2 of the present invention will be described. FIG. 10 is an illustration of a structure relation of the image heating apparatus of this embodiment. FIG. 11 illustrates the arrangement of the electroconductive lines on the substrate 610.

In Embodiment 1, the heat generation region of the heat generating element 620 is switched between a heat generation region A and a heat generation region B (Two patterns). In Embodiment 2, the heat generation region of the heat generating element 620 is switched between a heat generation region A, a heat generation region B and a heat generation region C. With this structure of this embodiment, the sheet P can be heated with more suitable heat generation widths for a variety of width sizes of the sheets. The structures of the fixing device 40 of Embodiment 2 are fundamentally the same as those of Embodiment 1 except for the structures relating to the heater 600. In the description of this embodiment, the same reference numerals as in Embodiment 1 are assigned to the elements having the corresponding functions in this embodiment, and the detailed description thereof is omitted for simplicity.

As shown in FIG. 10, the heater 600 of this embodiment can switch the heat generation region of the heat generating element 620 between the heat generation region A, the heat generation region B and the heat generation region C. The structure of the heater 600 of this embodiment will be described.

In this embodiment, the heat generating element 620 is divided into 12 sections by three common electrodes 642. Furthermore, each section is divided by two opposite electrodes provided in the middle portion thereof so that the heat generating element is divided 24 sub-sections. In this embodiment, a switch SW673 is provided in addition to the switch SW653 and switch SW663. On the substrate 610, an electrical contact 671 is provided in addition to the electrical contacts 641, 651, 661.

The electrical contact 671 (671a, 671b) contacts the terminal 740 (740a, 740b), by which it is electrically connected with the switch SW673. The switch SW673 is a switch provided between the voltage source contact 110b and the electrical contact 671. The switch SW673 connects or disconnects between the voltage source contact 110a and the electrical contact 671 in accordance with the instructions from the control circuit 100.

With such a structure, the heater 600 of this embodiment can switch the heat generation region of the heat generating element 620 between three patterns.

When the control circuit 100 receives the execution instructions of a job, the control circuit 100 acquires the width size information of the sheet P to be subjected to the fixing process. It controls the combination of ON/OFF of the switch SW643, switch SW653, switch SW663, and switch SW673 in accordance with the width information of the sheet P so as to provide proper heat generation width for the sheet P.

When the sheet P is a large size sheet (longitudinal feeding of the A3 size sheet, for example, or lateral feeding of the A4 size sheet P), the control circuit 100 causes the heat generating element 620 to generate heat in the heat generation width B. To effect this, the control circuit 100 renders ON all of the switch SW643, switch SW653, switch SW663 and switch SW673. At this time, the heater 600 generates the heat uniformly over the approx. 320 mm region to meet the approx. 297 mm sheet P.

When the sheet P is a middle size sheet (longitudinal feeding of the B4 size sheet, lateral feeding of the B5 size sheet, for example), the width size of the sheet P is approx. 257 mm. Therefore, the control circuit 100 causes the heat generating element 620 to generate the heat in the heat generation width C. More particularly, the control circuit 100 renders ON the switch SW643, switch SW653, switch SW663 and renders OFF the switch SW673. A result, 20 sub-sections of the 24 sub-sections of the heat generating element 620 generate heat. At this time, the heater 600 generates heat uniformly in the range of approx. 267 mm, and therefore, it is suitable for heating the approx. 257 mm width sheet.

When the sheet P is a small size sheet (longitudinal feeding of the A4 size sheet, or lateral feeding of the A5 size, for example), the controller effect controlling to generate the heat on the heat generation width A. Therefore, the control circuit 100 renders ON the switch SW643, switch SW653 and renders OFF the switch SW673. A result, 16 sub-sections of the 24 sub-sections of the heat generating element 620 generate heat. At this time, the heater 600 generates the heat uniformly over the approx. 213 mm region to meet the approx. 210 mm sheet P.

The arrangement of the electroconductive lines on the substrate 610 in this embodiment will be described. As shown in FIG. 11, the opposite electroconductive line 670a connected with the electrical contact 671a connected with the electrical contact 671a and the opposite electrode 672a, and the opposite electroconductive line 670b connected with the electrical contact 671b and the opposite electrode 672b are extended along the longitudinal direction of the substrate 610. The opposite electroconductive lines 670a, 670b are extended substantially with each other adjacent to the heat generating element 620 in the central region 610c (FIG. 4) of the substrate 610. In this embodiment, the opposite electroconductive lines 670a, 670b are spaced from the heat generating element 620 by approx. 400 μm in the widthwise direction of the substrate 610. That is, a gap B of approx. 400 μm is provided between the heat generating element 620 and the opposite electroconductive line 670. The gap B is provided to assure the insulation between the opposite electroconductive line 670 and the common electrode (642a, for example) by the insulation coating layer 680, and the minimum value is approx. 400 μm. The opposite electroconductive line 670 and the opposite electrode (642a, for example) are connected to different voltage source contacts (110a and 110b), and therefore, the gap B is relatively large for safety.

The opposite electroconductive line 660a connected with the electrical contact 661a and the opposite electrode 662a, and the opposite electroconductive line 660b connected with the electrical contact 661b and the opposite electrode 662b are extended in the longitudinal direction of the substrate 610. In the central region 610c of the substrate 610, the opposite electroconductive line 660a are extended substantially parallel with the opposite electroconductive line 670a adjacent thereto. In the central region 610c of the substrate 610, the opposite electroconductive line 660b are extended substantially parallel with the opposite electroconductive line 670b adjacent thereto. In this embodiment, the opposite electroconductive line 660a is spaced from the opposite electroconductive lines 670a by approx. 100 μm in the widthwise direction of the substrate 610. The opposite electroconductive line 660b disposed at the position approx. 100 μm away from the opposite electroconductive line 670a in the widthwise direction of the substrate 610. That is, a gap C of approx. 100 μm is provided between the opposite electroconductive line 670 and the opposite electroconductive line 660.

The gap C is required for arranging the opposite electroconductive line 670 and the opposite electroconductive line 660 as separate electroconductive lines. The opposite electroconductive line 660 and the opposite electroconductive line 650 are connected to the same voltage source contact, and therefore, the gap C may be small. The width of the substrate 610 can be reduced by the amount of reduction of the gap C. For this reason, it will not suffice even if the gap C is less than gap A locally, but it is desirable that the gap C is less than gap A over the entire area in which the opposite electroconductive line 660 and the opposite electroconductive line 650 extend substantially in parallel with each other.

The opposite electroconductive line 650 connected with the opposite electrode 652, the electrical contact 651a and the electrical contact 651b is extended along the longitudinal direction of the substrate 610. More particularly, in the central region 610c of the substrate 610, it is extended in parallel with and adjacent to the opposite electroconductive lines 660a, 660b. In this embodiment, the opposite electroconductive line 650 is spaced from the opposite electroconductive lines 660a, 660b by approx. 100 μm in the widthwise direction of the substrate 610. That is, a gap D of approx. 100 μm is provided between the opposite electroconductive line 650 and the opposite electroconductive line 660a, 660b.

The gap D is required for arranging the opposite electroconductive line 660 and the opposite electroconductive line 650 as separate electroconductive lines. The opposite electroconductive line 660 and the opposite electroconductive line 650 are connected to the same voltage source contact, and therefore, the gap C may be small. The width of the substrate 610 can be reduced by the amount of reduction of the gap C. For this reason, it will not suffice even if the gap C is less than gap A locally, but it is desirable that the gap C is less than gap A over the entire area in which the opposite electroconductive line 660 and the opposite electroconductive line 650 extend substantially in parallel with each other.

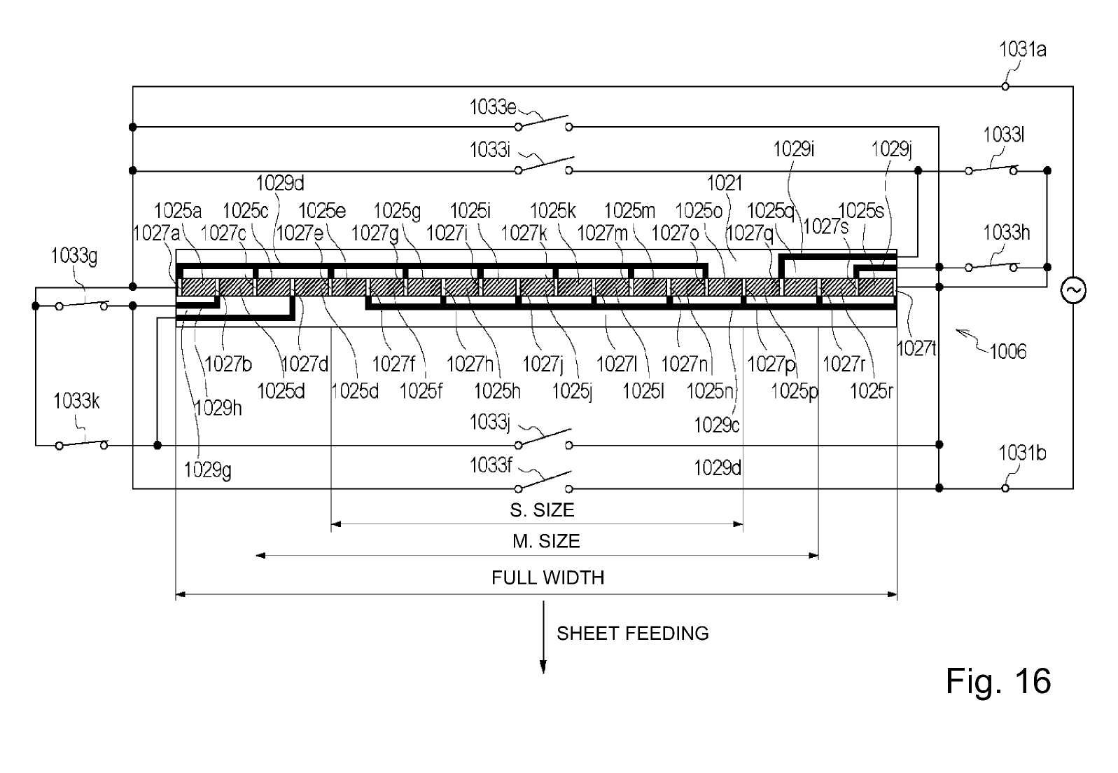

A comparison example will be explained, as compared with this embodiment. FIG. 16 is a circuit diagram of the heat generating element of conventional example 1 disclosed in Japanese Laid-open Patent Application 2012-37613. In conventional example 1, an electroconductive line layer 1029g and an electroconductive line layer 1029h are juxtaposed in the widthwise direction of the substrate 1021. In addition, an electroconductive line layer 1029i and an electroconductive line layer 1029j are juxtaposed in the widthwise direction of the substrate 1021. The electroconductive line layer 1029g and the electroconductive line layer 1029h are connected with different voltage source contacts, and the electroconductive line layer 1029i and the electroconductive line layer 1029j are connected with different voltage source contacts. Therefore, a large potential difference is produced between the electroconductive line layer 1029g and the electroconductive line layer 1029h, and between the electroconductive line layer 1029i and the electroconductive line layer 1029j. Therefore, for the prevention of the short circuit prevention between the electroconductive lines, a large gap is preferably provided between the electroconductive line layer 1029g and the electroconductive line layer 1029h and also between the electroconductive line layer 1029i and the electroconductive line layer 1029j.

In the conventional example 1, if the gap between the electroconductive lines connected to the different voltage source contacts is approx. 400 μm, this embodiment is effective to reduce the width of the space required for the electroconductive lines in the widthwise direction by approx. 600 μm.

In the case of the heater 600 with which the heat generation region of the heat generating element 620 is switchable between three patterns as in this embodiment, the number of the electroconductive lines arranged in the widthwise direction on the substrate 610 is larger than in Embodiment 1. That is, the increase of the number of the patterns of the heat generation region results in the increase of the number of the electroconductive line arranged in the widthwise direction on the substrate 610. Therefore, the increase of the patterns of the heat generation region of the heat generating element 620 leads to a sizing of the substrate 610 in the widthwise direction. However, according to this embodiment, the increased electroconductive lines are all connected to the same voltage source contact, and therefore, the gaps between the electroconductive lines can be reduced. In this embodiment, gap A>gap C=gap D (gap B>gap C=gap D) are satisfied. Therefore, the increase of the size of the substrate 610 in the widthwise direction attributable to the additional electroconductive lines on the substrate can be reduced. This applies to the case where the number of the patterns of the heat generation region of the heat generating element 620 is 4 or more.

According to this embodiment, even if the number of the patterns of the switchable heat generating region increases with the result of the increase of the number of the electroconductive lines on the substrate.

### Embodiment 3

A heater according to Embodiment 3 of the present invention will be described. FIG. 12 is an illustration of a structure relation of the image heating apparatus of this embodiment. FIG. 13 illustrates an arrangement of the electroconductive lines on the heater of this embodiment. In Embodiment 1, the heat generating element 620 is supplied with the electric energy from the electrical contacts disposed in the opposite longitudinal end portions of the substrate 610. In Embodiment 3, the heat generating element 620 it is supplied with the electric energy from the electrical contacts provided one longitudinal end portion of the substrate 610. More particularly, the electrical contact 661b and electrical contact 661a of Embodiment 1 are gathered into a common electrical contact 661a. The 651b electrical contact is gathered into the electrical contact 651a. The 651b electrical contact is gathered into the electrical contact 651a. With such a structure, the number of electrical contacts on the substrate 610 can be reduced. The description will be made in detail in conjunction with the accompanying drawings. The structures of the fixing device 40 of Embodiment 3 are fundamentally the same as those of Embodiment 1 except for the structures relating to the heater 600. In the description of this embodiment, the same reference numerals as in Embodiment 1 are assigned to the elements having the corresponding functions in this embodiment, and the detailed description thereof is omitted for simplicity.

The arrangement of the electroconductive lines on the substrate 610 in this embodiment will be described. As shown in FIG. 12, in the heater 600 of this embodiment, the electric energy supply to the heat generating element 620 is effected by the electrical contacts 641a, 651a, 661a provided in the one end portion side of the substrate 610 with respect to the longitudinal direction. The common electroconductive line 640 is extended along the longitudinal direction of substrate 610 toward the one end portion side 610a of the substrate, In the one end portion side of the substrate 610 with respect to the longitudinal direction. An end of the common electroconductive line 640 is connected to the electrical contact 641a. With this structure, the electrical contacts 641a, 641b in Embodiment 1 in gathered into a single electrical contact, by which one electrical contact is omitted.

In the opposite electroconductive line 650 extends along the longitudinal direction of the substrate 610 toward the one end portion side 610a of the substrate in another end portion side with respect to the widthwise direction substrate 610 beyond the heat generating element 620. The opposite electroconductive line 650 is connected to the electrical contact 651a. With this structure, the electrical contacts 651a, 651b in Embodiment 1 in gathered into a single electrical contact, by which one electrical contact is omitted.

In the opposite electroconductive line 660a extends along the longitudinal direction of the substrate 610 toward the one end portion side 610a of the substrate in another end portion side with respect to the widthwise direction substrate 610 beyond the heat generating element 620. An end of the opposite electroconductive line 660a is connected with the electrical contact 661a. In the opposite electroconductive line 660b extends along the longitudinal direction of the substrate 610 toward the one end portion side 610a of the substrate in another end portion side with respect to the widthwise direction substrate 610 beyond the heat generating element 620. An end of the opposite electroconductive line 660b is connected with the electrical contact 661a. The opposite electroconductive lines 660a and 660b surrounds the electrical contact 651a in the one end portion side of the substrate 610 with respect to the longitudinal direction. With the above-described structure, the electrical contact 661b of Embodiment 1 can be gathered into the single electrical contact 661a.

In the foregoing examples, three electrical contacts can be omitted as compared with Embodiment 1, and therefore, the length of the substrate 610 can be reduced by approx. 9 mm. In Embodiment 1, the gap of approx. 26 mm between the common electrode 642g and the electrical contact 651b in the longitudinal direction can be omitted. The gap is required mechanically when the connector 700 is mounted to the heater 600 provided in the belt 603.

With this structure in which the electric energy is supplied from one end portion side of the substrate as described above, the potential is asymmetrical in the longitudinal direction of the common electroconductive line 640 (between the one end portion side and the other end portion side with respect to the longitudinal direction). This is because a voltage drop is produced by the resistance of the electroconductive line per se. By the voltage drop attributable to the electroconductive line per se, the electric power supplied to the heat generating element 620 is asymmetrical in the longitudinal direction, with the possible result of non-uniformity heat generation of the heat generating element 620. In consideration of the heat generation non-uniformity of the heat generating element 620, a symmetrical arrangement of Embodiment 1 is preferable. However, the voltage drop attributable to the resistance of the electroconductive line is so small that it is negligible in the fixing process operation. Therefore, in this embodiment, the electric energy supply to the heater is effected from one end portion side 610a of the substrate.

The opposite electroconductive line 660a connected to the electrical contact 661a and the opposite electrode 662a extends in the longitudinal direction of the substrate 610. In the central region 610c of the substrate 610, the opposite electroconductive line 670a is extended substantially in parallel with the heat generating element 620 adjacent thereto. In this embodiment, the opposite electroconductive line 670a is spaced away from the heat generating element 620 by approx. 400 μm in the widthwise direction of the substrate 610. That is, a gap B of approx. 400 μm is provided between the heat generating element 620 and the opposite electroconductive line 660. The gap B is provided to assure the insulation between the opposite electroconductive line 670 and the common electrode (642a, for example), and when the insulation coating layer 680 is provided, it is approx. 400 μm. The opposite electroconductive line 670 and the opposite electrode (642a, for example) are connected to different voltage source contacts (110a and 110b), and therefore, the gap B is relatively large for safety.

The opposite electroconductive line 660a connected to the electrical contact 651a and the opposite electrode 652a extends in the longitudinal direction of the substrate 610. In the central region 610c of the substrate 610, the opposite electroconductive line 650 are extended substantially parallel with the opposite electroconductive line 660a adjacent thereto. In this embodiment, the opposite electroconductive line 650 is spaced from the opposite electroconductive lines 660a by approx. 100 μm in the widthwise direction of the substrate 610. That is, a gap of approx. 100 μm is provided between the opposite electroconductive line 670 and the opposite electroconductive line 660a, 660b.

The gap C is required for arranging the opposite electroconductive line 670 and the opposite electroconductive line 660 as separate electroconductive lines. The opposite electroconductive line 660a and the opposite electroconductive line 650 are connected to the same voltage source contact, and therefore, the gap C can be made small. The width of the substrate 610 can be reduced by the amount of reduction of the gap C. For this reason, it will not suffice even if the gap C is less than gap A locally, but it is desirable that the gap C is less than gap A over the entire area in which the opposite electroconductive line 660 and the opposite electroconductive line 650 extend substantially in parallel with each other.

The opposite electroconductive line 660b connected to the electrical contact 651a and the opposite electrode 662b extends in the longitudinal direction of the substrate 610. More particularly, in the central region 610c of the substrate 610 (FIG. 4), it is extended substantially in parallel with the opposite electroconductive line 650 adjacent thereto. In this embodiment, the opposite electroconductive line 660b is spaced from the opposite electroconductive lines 650 by approx. 100 μm in the widthwise direction of the substrate 610. That is, a gap of approx. 100 μm is provided between the opposite electroconductive line 650 and the opposite electroconductive line 660a, 660b.

The gap D is required for arranging the opposite electroconductive line 660 and the opposite electroconductive line 650 as separate electroconductive lines. The opposite electroconductive line 660 and the opposite electroconductive line 650 are connected to the same voltage source contact, and therefore, the gap C may be small. The width of the substrate 610 can be reduced by the amount of reduction of the gap C. For this reason, it will not suffice even if the gap C is less than gap A locally, but it is desirable that the gap C is less than gap A over the entire area in which the opposite electroconductive line 660 and the opposite electroconductive line 650 extend substantially in parallel with each other.

In the case that a single electrical contact 641a contacts to the plurality of heat generating elements 620a, 620b, 620k and 620l distributed in the longitudinal direction of the longitudinal direction of the heat generating element 620 as in this embodiment, the number of the electroconductive lines arranged in the widthwise direction on the substrate 610 is larger than that in Embodiment 1. If an attempt is made to gather the electrical contacts into a single electrical contact, the number of the electroconductive lines arranged in the widthwise direction of the substrate 610 increases. However, in this embodiment, the additional electroconductive lines are all connected with the same voltage source contact, and therefore, the gaps can be reduced. In this embodiment, gap A>gap C=gap D (gap B>gap C=gap D) are satisfied. Therefore, the increase of the width of the substrate 610 can be suppressed.

According to this embodiment, even if a plurality of heat generating elements is gathered into a single electrical contact with the result of the increase of the number of electroconductive lines, the gaps between the electroconductive lines can be reduced. Therefore, the increase of the size of the substrate 610 in the widthwise direction attributable to the additional electroconductive lines on the substrate can be reduced. This embodiment can be applied to Embodiment 2 as well as Embodiment 1.

### Embodiment 4

A heater according to Embodiment 4 of the present invention will be described. FIG. 14 illustrates an arrangement of the electroconductive lines on the heater of this embodiment. In Embodiment 3, in the one end portion side of the substrate 610 with respect to the longitudinal direction, the electrical contacts are arranged in the longitudinal direction of the substrate 610 at regular intervals, and the increase of the length of the substrate 610 is suppressed by reducing the number of the electrical contacts. On the other hand, in this embodiment, the distance between the electrical contacts 651a, 661a connected to the same voltage source contact is reduced, in addition to the structure of Embodiment 3. With such a structure, the area on the substrate 610 required by the provision of the electrical contacts can be reduced, and therefore, the upsizing of the substrate 610 in the longitudinal direction can be further suppressed. The description will be made in detail in conjunction with the accompanying drawings. The structures of the fixing device 40 of Embodiment 4 are fundamentally the same as those of Embodiment 3 except for the structures relating to the heater 600. In the description of this embodiment, the same reference numerals as in Embodiment 3 are assigned to the elements having the corresponding functions in this embodiment, and the detailed description thereof is omitted for simplicity.

The electrical contacts 641a, 651a, 661a are not coated with the insulation coating layer 680, and the surfaces thereof are exposed, and therefore, it is desirable to provide insulation distance to assure the prevention of the leakage and/or short circuit. With the increase of the insulation distance, the possibility of the leakage and/or short circuit decreases, but on the other hand, when the electrical contacts are arranged in the longitudinal direction in Embodiment 1, the length of the substrate 610 increases. Therefore, it is preferable to provide a proper gap between adjacent electrical contacts.

In this embodiment, the electrical contact 641 is connected to the voltage source contact 110a, and the electrical contact 661a is connected to the voltage source contact 110b. That is, the electrical contacts 641a and 661a are connected to different voltage source contacts. Therefore, the short circuit due to the creepage discharge tends to occur between the electrical contacts 641a and 661a. Therefore, between the electrical contact 641 and the electrical contact 661, a gap (gap E) of not less than 2.5 mm which is the insulation distance for preventing the) is preferably provided. In this embodiment, the gap E is approx. 4 mm in consideration of the mounting tolerances of the connector 700 and/or the thermal expansion of the substrate 610. When the gap between the electrical contacts 641a and 661a is not constant because of non-parallelism between the electrical contacts 641a and 661a, a minimum value of the gap is deemed as the gap E.

In this embodiment, the electrical contacts 651a, 661b are connected to the voltage source contact 110b. Therefore, the electrical contacts 61a and 661a are connected with the same voltage source contact. Therefore, the short circuit due to the creepage discharge hardly occurs between the electrical contacts 641a and 661a (gap F). Therefore, the insulation distance for preventing is creepage discharge is not taken into account in the case of the gap F. However, in consideration of the mounting tolerances of the connector 700 and/or the thermal expansion of the substrate 610, the gap F is approx. 1.5 mm in this embodiment. When the gap between the electrical contacts 641a and 661a is not constant because of non-parallelism between the electrical contacts 641a and 661a, a minimum value of the gap is deemed as the gap E.

From the stand point of the electrical contact 661a, this means the following. In the one end portion side, the electrical contact 661a as a third electrical contact and the electrical contact 641a as a first electrical contact are adjacent to each other in the longitudinal direction of the substrate 610. The gap between the electrical contact 661a and the electrical contact 651a (approx. 1.5 mm in this embodiment) is less than the gap between the electrical contact 661 and the electrical contact 641a (approx. 4 mm in this embodiment). That is, gap E>gap F is satisfied. By are arranged such that the gap between the electrical contact 661a and the electrical contact 651a is less than gap E over the entirety, the length of the substrate can be reduced.

The order of the electrical contacts is not limited to that described above. For example, the electrical contact 641a may be disposed at a position closer to the central region 610c of the substrate 610a. However, the electrical contact 641a connects with the voltage source contact (110a) which is different from the voltage source contact (110b) to which the other electrical contacts connect. Therefore, it is preferable that the electrical contact 641a is disposed at an end of an array of the electrical contacts.

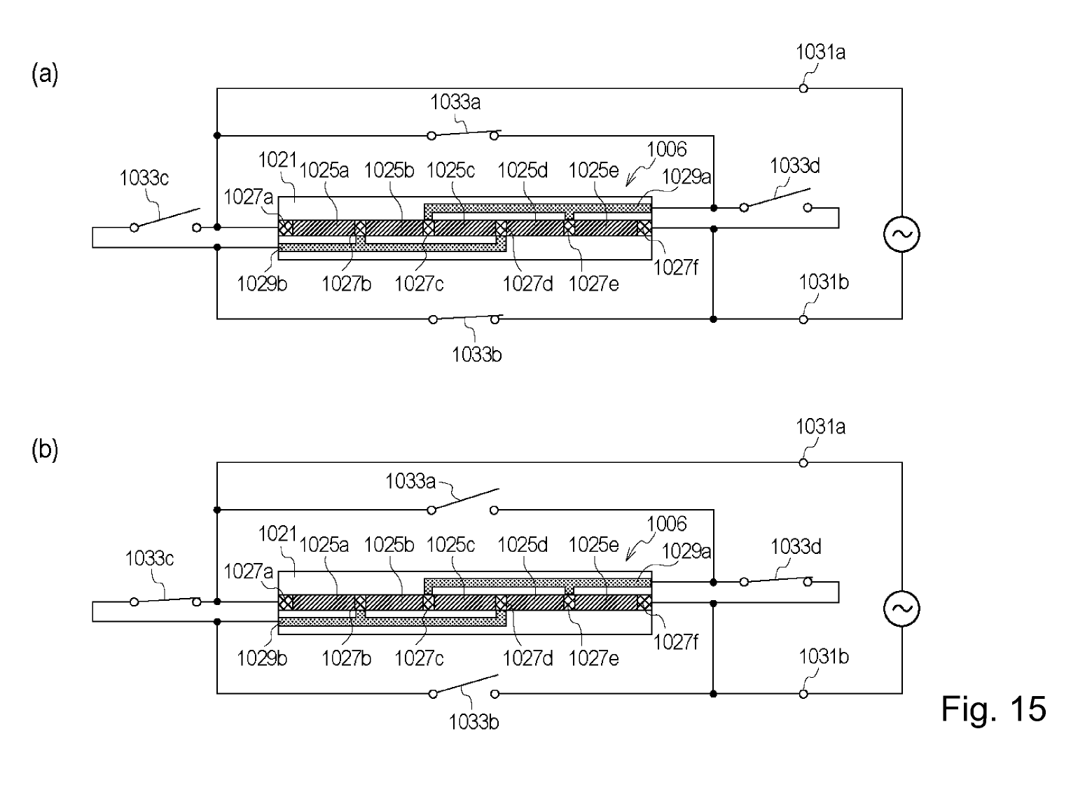

A comparison will be made between Embodiment 4 and a conventional example. FIG. 15 is a circuit diagram of the heater of conventional example 2 disclosed in Japanese Laid-open Patent Application 2012-37613. FIG. 16 is a circuit diagram of the heater of conventional example 1 described above. The heater 1006 of conventional example 2 is openable with two heat generating regions, wherein the arrangement of the electroconductive lines is different from that of Embodiment 1. The heater 1006 of conventional example 1 of FIG. 16 is openable with three heat generating regions, wherein the arrangement of the electroconductive lines is different from Embodiment 2.

In FIGS. 15 and 16, the electroconductive line layer 1029 connected to the electrodes 1025 extends to the longitudinal end portion of the substrate 1021. In the end portion of the substrate 1021, the electroconductive lines are exposed, and are connectable with voltage source contacts 1031 using the electroconductive line terminal (unshown). With this structure shown in FIGS. 15 and 16, the portions corresponding to the electrical contact of this embodiment are arranged in the widthwise direction of the substrate 1021 in the opposite end portions of the substrate 1021.

With such an arrangement, it is difficult to effect the electric power supply with the assured convention of the short circuit when the width of the substrate 610 is small as in this embodiment. Therefore, the comparison with this embodiment will be made on the basis of the heater 1006 using the electroconductive line arrangement of conventional example 1, conventional example 2 installed in the fixing device 40 having the same structure as in this embodiment. More specifically, in comparison example 1, the heater of the conventional example 2 is modified such that in the opposite longitudinal end portions, the electrical contacts are arranged in the longitudinal direction of the substrate. In comparison example 2, the heater of the conventional example 1 is modified such that in the opposite longitudinal end portions, the electrical contacts are arranged in the longitudinal direction of the substrate.

The arranging of the electrical contacts in the comparison example 1 and comparison example 2 is the same as that of the present invention. That is, the electrical contacts which can be gathered are gathered, and the gap between the electrical contacts which can be reduced are reduced.

In the heater of comparison example 1, the electroconductive lines are provided so as to be openable with two different width sheets. In the heater of comparison example 1, when the heat generating element generates heat for a large width sheet, an electroconductive line layer 1029c and an electroconductive line layer 1029e are connected with a voltage source contact 1031a, and an electroconductive line layer 1029f and an electroconductive line layer 1029d are connected with a voltage source contact 1031b, as shown in part (a) of FIG. 15. In the heater of conventional example 1, when the heat generating element generates heat for a small width sheet, an electroconductive line layer 1029c and an electroconductive line layer 1029f are connected with a voltage source contact 1031a, and an electroconductive line layer 1029e and an electroconductive line layer 1029d are connected with a voltage source contact 1031b, as shown in part (b) of FIG. 15. Therefore, the electroconductive line layers 1029c, 1029d, 1029e, 1029f are connected with different voltage source contact. The electrical contacts (unshown) connected with the electroconductive line layers 1029c, 1029d, 1029e, 1029f are connected with different voltage source contacts.

In comparison example 1, it is difficult to make a plurality of electroconductive lines into a single electrical contact as in this embodiment or Embodiment 3. In addition, it is also difficult to reduce the gaps between the electrical contacts as in this embodiment.

Therefore, the width of the region for an array of the electrical contact in the longitudinal range of the substrate 610 is approx. 24 mm (four approx. 3 mm electrical contacts plus two gaps of approx. 4 mm between the adjacent electrical contacts.

The heater of comparison example 2 is provided with electroconductive lines arranged so that the heater is openable with three width sheets (large, middle, and small). In the heater of comparison example 2, electroconductive line layers 1029c, 1029d, 1029g, 1029h, 1029i, 1029j are connected with different voltage source contacts. Therefore, the electrical contacts (unshown) connected with the electroconductive line layers 1029c, 1029d, 1029g, 1029h, 1029i, 1029j are also connected with different voltage source contacts.

In comparison example 2, it is difficult to make a plurality of electroconductive lines into a single electrical contact as in this embodiment or Embodiment 3. In addition, it is also difficult to reduce the gaps between the electrical contacts as in this embodiment.

Therefore, the width of the region for an array of the electrical contact in the longitudinal range of the substrate 610 is approx. 34 mm (six approx. 3 mm electrical contacts plus four gaps of approx. 4 mm between the adjacent electrical contacts.

On the other hand, in the case of the heater in this embodiment which is openable with two width sheets, the width of the array of the electrical contacts in the lines to a range of the substrate 610 is as follows. It is approx. 24 mm (three approx. 3 mm electrical contacts, one gap for an approx. 4 mm electrical contact, and one gap for approx. 1.5 mm electrical contact.

On the other hand, in the case of the heater in this embodiment which is openable with three width sheets, the width of the array of the electrical contacts in the lines to a range of the substrate 610 is as follows. It is approx. 19 mm (four approx. 3 mm electrical contacts, the gap for an approx. 4 mm electrical contact, and two gaps for approx. 1.5 mm electrical contacts.

The results of the above analysis are shown in Table 1. In the Table, the heater operable with two heat generating regions is Embodiment 4a, and the heater operable with three heat generating regions is Embodiment 4b.

TABLE 1

| | Emb. | Comp. Ex. | Emb. | Comp. Ex. |
|---|---|---|---|---|
| | 4a | 1 | 4b | 2 |
| Number of | 2 | 2 | 3 | 3 |
| heat generating | | | | |
| region pattern | | | | |
| Number of | 3 | 4 | 4 | 6 |
| electrodes | | | | |
| Total width of | 14.5 mm | 24 mm | 19 mm | 34 mm |
| electrode | | | | |
| portions | | | | |

As will be understood from Table 1, and other conditions that the numbers of the heat generation region patterns are the same, the electrical contact numbers small in this embodiment than in the conventional examples. Therefore, the structure relating to the electrical contacts can be simplified.

Since the number of the electrical contacts connected to the same voltage source contact is large, the gaps between the adjacent electrical contacts can be reduced when the electrical contacts is arranged in the longitudinal direction of the substrate 610. For this reason, a total width of the arrays of the electrical contacts (total width including the widths of the electrical contacts and the gaps) can be reduced, and therefore, the increase of the length of the substrate 610 can be suppressed when the electrical contacts are arranged in an array. In addition, the size of the connector 700 can be reduced.

When the length of the substrate 610 is fixed, a large number of patterns of the heat generation regions can be provided in this embodiment than in the formation of the examples.

In the foregoing, the length of the substrate 610 is further reduced as compared with Embodiment 3, but the present invention is not limited to such a case. The present invention is applicable if in one end portion side 610a of the substrate, a plurality of electrical contacts connected to the voltage source contact (110b) are arranged in the longitudinal direction of the substrate 610.

For example, the present invention is applicable is in the one end portion side 610a of the substrate three, electrical contacts are arranged in the longitudinal direction of the substrate 610, and the two electrical contacts of the three electrical contacts are connected to the same voltage source contact. More particularly, the electrical contact (641a, for example) connected to the voltage source contact 110a is disposed adjacent to one end of the electrical contact (661a, for example) connected to the voltage source contact 110b. In addition, the electrical contact (651a, for example) connected to the voltage source contact 110b is disposed adjacent to the other end portion side of the electrical contact (661a) connected to the voltage source contact 110b.

Therefore, the structure of this embodiment is applicable to the structures of Embodiments 1 and embodiment of 2. For example, in Embodiment 1, the gap between the electrical contact 661a (661b) and the electrical contact 651a (651b) can be made smaller than the gap between the electrical contact 641a (641b) and the electrical contact 661a (651b). Therefore in Embodiment 1 and Embodiments 2, the width of the arrays of the electrical contacts can be reduced in each of one and the other end portions of the substrate. Therefore, the length of the substrate 610 can be reduced.

In addition, this embodiment is applicable if two electrical contacts connected to the different voltage source contacts are provided in the one end portion side 610a of the substrate, and two electrical contacts connected to the same voltage source contact are provided in the other end portion side 610b of the substrate. Here, the gap between the two electrical contact connected to the same voltage source contact in the other end portion side 610b of the substrate can be made smaller than the gap between the two electrical contacts connected to the different voltage source contacts in the one end portion side 610a of the substrate.

In addition, this embodiment is applicable if the electrical contact connected to the voltage source contact 110a is provided in the one end portion side 610a of the substrate, and two electrical contacts connected to the voltage source contact 110b are provided in the other end portion side 610b of the substrate are arranged in the longitudinal direction In this case, the gap between the two electrical contacts connected to the voltage source contact 110b and the provided in the other end portion side 610b of the substrate is less than 2.5 mm.

In this embodiment, the electrical contacts are arranged in the longitudinal direction of the substrate 610, and the electrical contacts are not arranged in the widthwise direction of the substrate, for the purpose of preventing increase of the width of the substrate. However, in this embodiment, an electrical contact connected to the same voltage source contact can be disposed with a reduced gap. Therefore, even if the electrical contacts 661a and 671a of Embodiment 2 are arranged in the widthwise direction, this embodiment is applicable.

Therefore, the electrical contact (641a, for example) connected to the voltage source contact 110a is disposed adjacent to one end portion side of the electrical contact (661a, for example) connected to the voltage source contact 110b with respect to the longitudinal direction. The electrical contact (651a, for example) connected to the voltage source contact 110b is provided in the other end portion side of the electrical contact (662a, for example) connected to the voltage source contact 110b with respect to the longitudinal direction. The electrical contact (671a, for example) connected to the voltage source contact 110b is disposed adjacent to the other end portion side of the electrical contact (661a, for example) connected to the voltage source contact 110b with respect to the widthwise direction. With such an arrangement, the gap between the electrical contact 661a (661b) and the electrical contact 651a (661b) can be made smaller than the gap between the electrical contact 641a (641b) and the electrical contact 661a (651b). In addition, the gap between the electrical contact 671a and the electrical contact 651a can be made smaller than the gap between the electrical contact 641a and the electrical contact 671a.

The heater per se of the foregoing embodiments can be summarized as follows:

A heater comprising:

a substrate;

a plurality of electrode portions including a plurality of first electrode portions electrically connectable with one of a grounding and non-grounding side of an electric power source and a plurality of second electrode portions electrically connectable the other one of the grounding and non-grounding side, the first electrode portions and the second electrode portions are arranged in a longitudinal direction of the substrate with spaces between adjacent electrode portions;

a plurality of heat generating portions, provided between adjacent electrode portions, respectively, for generating heat by electric power supply between adjacent electrode portions;

a first electroconductive line portion electrically connected with the plurality of first electrode portions, the first electroconductive line portion being extending in the longitudinal direction with a gap between itself and the plurality of heat generating portions, in one end portion side with respect to a widthwise direction of the substrate beyond the plurality of heat generating portions;

a second electroconductive line portion electrically connected with the second electrode portion electrically connected with the heat generating portions in a first heat generating region arranged in the longitudinal direction, the second electroconductive line portion being extended in the longitudinal direction in the other end portion side with respect to the widthwise direction beyond the plurality of heat generating portions; and

a third electroconductive line portion electrically connected with the second electrode portion electrically connected with the heat generating portions in a second heat generating region arranged in the longitudinal direction, the second electroconductive line portion being extended adjacent to the second electroconductive line portion in the longitudinal direction in the other end portion side with respect to the widthwise direction beyond the plurality of heat generating portions,

wherein a gap between the second electroconductive line portion and the third electroconductive line portion in the widthwise direction is smaller than the gap between the first electroconductive line portion and the second electrode portion in the widthwise direction.

### Other Embodiment

The present invention is not restricted to the specific dimensions in the foregoing embodiments. The dimensions may be changed properly by one skilled in the art depending on the situations. The embodiments may be modified in the concept of the present invention.

The heat generating region of the heater 600 is not limited to the above-described examples which are based on the sheets are supplied with the center thereof aligned with the center of the fixing device. Alternatively, the heat generating regions of the heater 600 may be modified so as to meet the case in which the sheets are supplied with one end thereof aligned with an end of the fixing device. More particularly, the heat generating elements corresponding to the heat generating region A are not heat generating elements 620c-620j but are heat generating elements 620a-620e. With such an arrangement, when the heat generating region is switched from that for a small size sheet to that for a large size sheet, the heat generating region does not expand at both of the opposite end portions, cone. But expands at one of the opposite end portions.

The forming method of the heat generating element 620 is not limited to those disclosed in Embodiments 1, 2. In Embodiment 1, the common electrode 642 and the opposite electrodes 652, 662 are laminated on the heat generating element 620 extending in the longitudinal direction of the substrate 610. However, the electrodes are formed in the form of an array extending in the longitudinal direction of the substrate 610, and the heat generating elements 620a-620l may be formed between the adjacent electrodes.

The belt 603 is not limited to that supported by the heater 600 at the inner surface thereof and driven by the roller 70. For example, so-called belt unit type in which the belt is extended around a plurality of rollers and is driven by one of the rollers. However, the structures of Embodiments 1-4 of preferable from the standpoint of low thermal capacity.

The member cooperative with the belt 603 to form of the nip N is not limited to the roller member such as a roller 70. For example, it may be a so-called pressing belt unit including a belt extended around a plurality of rollers.

The image forming apparatus which has been a printer 1 is not limited to that capable of forming a full-color, but it may be a monochromatic image forming apparatus. The image forming apparatus may be a copying machine, a facsimile machine, a multifunction machine having the function of them, or the like, for example.

The image heating apparatus is not limited to the apparatus for fixing a toner image on a sheet P. It may be a device for fixing a semi-fixed toner image into a completely fixed image, or a device for heating an already fixed image. Therefore, the fixing device 40 as the image heating apparatus may be a surface heating apparatus for adjusting a glossiness and/or surface property of the image, for example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-108591 filed on May 26, 2014, which is hereby incorporated by reference herein in its entirety.

What is claimed is:

1. A heater usable with an image heating apparatus including an electric energy supplying portion provided with a first terminal and a second terminal, and an endless belt for heating an image on a sheet, wherein said heater is contactable to the belt to heat the belt, said heater comprising:
a substrate;
a plurality of electrode portions including a plurality of first electrode portions electrically connectable with the first terminal and a plurality of second electrode portions electrically connectable the second terminal, said first electrode portions and said second electrode portions are arranged in a longitudinal direction of said substrate with spaces between adjacent electrode portions;
a plurality of heat generating portions, provided between adjacent electrode portions, respectively, for generating heat by electric power supply between adjacent electrode portions;
a first electroconductive line portion electrically connected with said plurality of first electrode portions, said first electroconductive line portion being extending in the longitudinal direction with a gap between itself and said plurality of heat generating portions, in one end portion side with respect to a widthwise direction of said substrate beyond said plurality of heat generating portions;
a second electroconductive line portion electrically connected with said second electrode portion electrically connected with said heat generating portions in a first heat generating region arranged in the longitudinal direction, said second electroconductive line portion being extended in the longitudinal direction in the other end portion side with respect to the widthwise direction beyond said plurality of heat generating portions; and
a third electroconductive line portion electrically connected with said second electrode portion electrically connected with said heat generating portions in a second heat generating region arranged in the longitudinal direction, said second electroconductive line portion being extended adjacent to said second electroconductive line portion in the longitudinal direction in the other end portion side with respect to the widthwise direction beyond said plurality of heat generating portions;
wherein a gap between said second electroconductive line portion and said third electroconductive line portion in the widthwise direction is smaller than the gap between said first electroconductive line portion and said second electrode portion in the widthwise direction.

2. A heater according to claim 1, wherein said second electroconductive line portion is outside said third electroconductive line portion with respect to the widthwise direction, and a gap between said second electroconductive line portion and said third electroconductive line portion in the widthwise direction is smaller than a gap between said first electroconductive line portion and said second electroconductive line portion in an outside of said plurality of heat generating portions with respect to the longitudinal direction.

3. A heater according to claim 2, wherein a contact portion electrically connected with said third electroconductive line portion and electrically connectable with the second terminal through a connector portion of the electric energy supplying portion in one end portion side of the substrate with respect to the longitudinal direction beyond the plurality of heat generating portions, and said contact portion is extended adjacent to said first electroconductive line portion and said second electroconductive line portion with respect to the widthwise direction.

4. A heater according to claim 1, further comprising,
a first contact portion provided in one end portion side of said substrate beyond said plurality of heat generating portions with respect to the longitudinal direction, electrically connected with said first electroconductive line portion and electrically connectable with the second terminal through a connector portion of an electric energy supplying portion;
a second contact portion provided in the one end portion side of said substrate beyond said plurality of heat generating portions with respect to the longitudinal direction, electrically connected with said second electroconductive line portion and electrically connectable with the second terminal through the connector portion; and
a third contact portion provided in the one end portion side of said substrate beyond said plurality of heat generating portions with respect to the longitudinal direction, electrically connected with said third electroconductive line portion and electrically connectable with the second terminal through the connector portion, wherein said first contact portion is adjacent to one end portion side of said second contact portion with respect to the longitudinal direction, and said third contact portion is adjacent to the other end portion side of said second contact portion with respect to the longitudinal direction,
wherein a gap between said second electroconductive line portion and said third electroconductive line portion in the widthwise direction is smaller than a gap between said second contact portion and said third contact portion in the longitudinal direction.

5. A heater according to claim 1, further comprising,
a first contact portion provided in one end portion side of said substrate beyond said plurality of heat generating portions with respect to the longitudinal direction, electrically connected with said first electroconductive line portion and electrically connectable with the second terminal through a connector portion of an electric energy supplying portion;
a second contact portion provided in the one end portion side of said substrate beyond said plurality of heat generating portions with respect to the longitudinal direction, electrically connected with said second electroconductive line portion and electrically connectable with the second terminal through the connector portion; and
a third contact portion provided in the one end portion side of said substrate beyond said plurality of heat generating portions with respect to the longitudinal direction, electrically connected with said third electroconductive line portion and electrically connectable with the second terminal through the connector portion, wherein said first contact portion is adjacent to one end portion side of said second contact portion with respect to the longitudinal direction, and said third contact portion is adjacent to the other end portion side of said second contact portion with respect to the longitudinal direction,
wherein a gap between said second electrode portion and said first electroconductive line portion in the widthwise direction is smaller than a gap between said first contact portion and said second contact portion in the longitudinal direction.

6. A heater according to claim 1, further comprising,
a first contact portion provided in one end portion side of said substrate beyond said plurality of heat generating portions with respect to the longitudinal direction, electrically connected with said first electroconductive line portion and electrically connectable with the second terminal through a connector portion of an electric energy supplying portion;
a second contact portion provided in the one end portion side of said substrate beyond said plurality of heat generating portions with respect to the longitudinal direction, electrically connected with said second electroconductive line portion and electrically connectable with the second terminal through the connector portion; and
a third contact portion provided in the one end portion side of said substrate beyond said plurality of heat generating portions with respect to the longitudinal direction, electrically connected with said third electroconductive line portion and electrically connectable with the second terminal through the connector portion, wherein said first contact portion is adjacent to one end portion side of said second contact portion with respect to the longitudinal direction, and said third contact portion is adjacent to the other end portion side of said second contact portion with respect to the longitudinal direction,
wherein a gap between said second contact portion and said third contact portion in the longitudinal direction is smaller than a gap between said first contact portion and said second contact portion in the longitudinal direction.

7. An image heating apparatus comprising:
an electric energy supplying portion provided with a first terminal and a second terminal;
a belt configured to heat an image on a sheet;
a substrate provided inside said belt and extending in a widthwise direction of said belt;
a plurality of electrode portions including a plurality of first electrode portions electrically connectable the first terminal and a plurality of second electrode portions electrically connectable the second terminal, said first electrode portions and said second electrode portions are arranged in a longitudinal direction of said substrate with spaces between adjacent electrode portions;
a plurality of heat generating portions, provided between adjacent electrode portions, respectively, for generating heat by electric power supply between adjacent electrode portions,
a first electroconductive line portion electrically connected with said plurality of first electrode portions, said first electroconductive line portion being extending in the longitudinal direction with a gap between itself and said plurality of heat generating portions, in one end portion side with respect to a widthwise direction of said substrate beyond said plurality of heat generating portions;
a second electroconductive line portion electrically connected with said second electrode portion electrically connected with said heat generating portions in a first heat generating region arranged in the longitudinal direction, said second electroconductive line portion being extended in the longitudinal direction in the other end portion side with respect to the widthwise direction beyond said plurality of heat generating portions; and
a third electroconductive line portion electrically connected with said second electrode portion electrically connected with said heat generating portions in a second heat generating region arranged in the longitudinal direction, said second electroconductive line portion being extended adjacent to said second electroconductive line portion in the longitudinal direction in the other end portion side with respect to the widthwise direction beyond said plurality of heat generating portions;
wherein when a sheet having a maximum width usable with said apparatus is heated, electric energy is supplied through said first electroconductive line and all of electroconductive line portions including said second electroconductive line portion and said third electroconductive line portion so that all of said heat generating portions generate heat, and wherein when a sheet having a width smaller than the maximum width is heated, electric energy is supplied through said first electroconductive line portion and a part of said electroconductive line portions so that a part of said heat generating portions generate heat, and
wherein a gap between said second electroconductive line portion and said third electroconductive line portion in the widthwise direction is smaller than the gap between said first electroconductive line portion and said second electrode portion in the widthwise direction

8. An apparatus according to claim 7, wherein said second electroconductive line portion is outside said third electroconductive line portion with respect to the widthwise direction, and a gap between said second electroconductive line portion and said third electroconductive line portion in the widthwise direction is smaller than a gap between said first electroconductive line portion and said second electroconductive line portion in an outside of said plurality of heat generating portions with respect to the longitudinal direction.

9. An apparatus according to claim 8, wherein a contact portion electrically connected with said third electroconductive line portion and electrically connectable with the second terminal through a connector portion of the electric energy supplying portion in one end portion side of the substrate with respect to the longitudinal direction beyond the plurality of heat generating portions, and said contact portion is extended adjacent to said first electroconductive line portion and said second electroconductive line portion with respect to the widthwise direction.

10. An apparatus according to claim 7, wherein said heater further includes,
a first contact portion provided in one end portion side of said substrate beyond said plurality of heat generating portions with respect to the longitudinal direction, electrically connected with said first electroconductive line portion and electrically connectable with the second terminal through a connector portion of an electric energy supplying portion;
a second contact portion provided in the one end portion side of said substrate beyond said plurality of heat generating portions with respect to the longitudinal direction, electrically connected with said second electroconductive line portion and electrically connectable with the second terminal through the connector portion; and
a third contact portion provided in the one end portion side of said substrate beyond said plurality of heat generating portions with respect to the longitudinal direction, electrically connected with said third electroconductive line portion and electrically connectable with the second terminal through the connector portion, wherein said first contact portion is adjacent to one end portion side of said second contact portion with respect to the longitudinal direction, and said third contact portion is adjacent to the other end portion side of said second contact portion with respect to the longitudinal direction,
wherein a gap between said second electroconductive line portion and said third electroconductive line portion in the widthwise direction is smaller than a gap between said second contact portion and said third contact portion in the longitudinal direction.

11. An apparatus according to claim 7, wherein said heater further includes,
a second contact portion provided in the one end portion side of said substrate beyond said plurality of heat generating portions with respect to the longitudinal direction, electrically connected with said second electroconductive line portion and electrically connectable with the second terminal through the connector portion; and
a third contact portion provided in the one end portion side of said substrate beyond said plurality of heat generating portions with respect to the longitudinal direction, electrically connected with said third electroconductive line portion and electrically connectable with the second terminal through the connector portion, wherein said first contact portion is adjacent to one end portion side of said second contact portion with respect to the longitudinal direction, and said third contact portion is adjacent to the other end portion side of said second contact portion with respect to the longitudinal direction,
wherein a gap between said second electrode portion and said first electroconductive line portion in the widthwise direction is smaller than a gap between said first contact portion and said second contact portion in the longitudinal direction

12. An apparatus according to claim 7, wherein said heater further includes a first contact portion provided in one end portion side of said substrate beyond said plurality of heat generating portions with respect to the longitudinal direction, electrically connected with said first electroconductive line portion and electrically connectable with the second terminal through a connector portion of an electric energy supplying portion;
a second contact portion provided in the one end portion side of said substrate beyond said plurality of heat generating portions with respect to the longitudinal direction, electrically connected with said second electroconductive line portion and electrically connectable with the second terminal through the connector portion; and
a third contact portion provided in the one end portion side of said substrate beyond said plurality of heat generating portions with respect to the longitudinal direction, electrically connected with said third electroconductive line portion and electrically connectable with the second terminal through the connector portion, wherein said first contact portion is adjacent to one end portion side of said second contact portion with respect to the longitudinal direction, and said third contact portion is adjacent to the other end portion side of said second contact portion with respect to the longitudinal direction,
wherein a gap between said second contact portion and said third contact portion in the longitudinal direction is smaller than a gap between said first contact portion and said second contact portion in the longitudinal direction.

13. An apparatus according to claim 7, wherein when the heat generating portions are supplied with electric energy through all of said first and second contact portions, the directions of electric currents through adjacent ones of heat generating portions are opposite to each other.

14. An apparatus according to claim 7, wherein said electric energy supplying portion includes an AC circuit.

15. A heater comprising:
a substrate;
a plurality of electrode portions including a plurality of first electrode portions electrically connectable with one of a grounding and non-grounding side of an electric power source and a plurality of second electrode portions electrically connectable the other one of the grounding and non-grounding side, the first electrode portions and the second electrode portions are arranged in a longitudinal direction of the substrate with spaces between adjacent electrode portions;
a plurality of heat generating portions, provided between adjacent electrode portions, respectively, for generating heat by electric power supply between adjacent electrode portions;
a first electroconductive line portion electrically connected with the plurality of first electrode portions, the first electroconductive line portion being extending in the longitudinal direction with a gap between itself and the plurality of heat generating portions, in one end portion side with respect to a widthwise direction of the substrate beyond the plurality of heat generating portions;
a second electroconductive line portion electrically connected with the second electrode portion electrically connected with the heat generating portions in a first heat generating region arranged in the longitudinal direction, the second electroconductive line portion being extended in the longitudinal direction in the other end portion side with respect to the widthwise direction beyond the plurality of heat generating portions; and
a third electroconductive line portion electrically connected with the second electrode portion electrically connected with the heat generating portions in a second heat generating region arranged in the longitudinal direction, the second electroconductive line portion being extended adjacent to the second electroconductive line portion in the longitudinal direction in the other end portion side with respect to the widthwise direction beyond the plurality of heat generating portions,
wherein a gap between the second electroconductive line portion and the third electroconductive line portion in the widthwise direction is smaller than the gap between the first electroconductive line portion and the second electrode portion in the widthwise direction.
